(19) United States
(12) Patent Application Publication
(10) Pub. No.: US 2022/0385846 A1
(43) Pub. Date: Dec. 1, 2022

(54) IMAGING ELEMENT AND IMAGING APPARATUS

(71) Applicant: SONY SEMICONDUCTOR SOLUTIONS CORPORATION, KANAGAWA (JP)

(72) Inventor: YUKI HIGUCHI, TOKYO (JP)

(21) Appl. No.: 17/755,731

(22) PCT Filed: Oct. 27, 2020
(86) PCT No.: PCT/JP2020/040159

§ 371 Date: May 6, 2022

(30) Foreign Application Priority Data
Nov. 15, 2019 (JP) 2019-207407

(51) Int. Cl. H04N 5/378; H04N 5/3745; H04N 5/376; H04N 5/357; H02M 3/07

(52) U.S. Cl. CPC H04N 5/378; H04N 5/3745; H04N 5/3765; H04N 5/3575; H02M 3/07

(57) ABSTRACT

To make it possible to reduce power consumption in a charge pump that supplies driving power to a pixel array. An imaging element (4) according to an embodiment includes: an imaging unit (100) in which pixels (10) including a light receiving element are arrayed, a drive unit (112) that generates a drive signal for driving the pixels, a charge pump circuit (122) that generates electric power for driving the drive unit, and a control unit (120) that controls, according to operation of the imaging unit, a driving capability of the charge pump circuit to drive the drive unit.

### FIELD

The present disclosure relates to an imaging element and an imaging apparatus.

### BACKGROUND

A configuration is known in which driving power for driving light receiving elements is supplied to, using a charge pump, a pixel array in which the light receiving elements (for example, photodiodes) are arranged in a matrix. As one of the configurations of the charge pump, there is known a charge pump in which a switching signal that is switched on/off according to a clock is applied to a capacitor to accumulate electric charges in the capacitor and, for example, a high voltage is output with respect to an input voltage.

### CITATION LIST

### Patent Literature

Patent Literature 1: Japanese Patent Application Laid-Open No. 2006-319684
Patent Literature 2: Japanese Patent Application Laid-Open No. 2008-136047

### SUMMARY

### Technical Problem

In the above-described pixel array, when a driving operation is simultaneously executed in all the light receiving elements effective for imaging, a large potential fluctuation occurs in the driving power for driving the light receiving elements. As an example, when a global shutter scheme is adopted as an imaging scheme, for example, a reset operation for the light receiving elements or a transfer operation for transferring electric charges accumulated in the light receiving elements by exposure to a capacitor is simultaneously executed in all the light receiving elements effective for imaging included in the pixel array. A large potential fluctuation occurs in the driving power. When the charge pump is configured according to the peak of the potential fluctuation, unnecessary power is consumed in a period other than a period in which the potential fluctuation occurs.

An object of the present disclosure is to provide an imaging element and an imaging apparatus capable of reducing power consumption in a charge pump that supplies driving power to a pixel array.

### Solution to Problem

For solving the problem described above, an imaging element according to one aspect of the present disclosure has an imaging unit in which pixels including a light receiving element are arrayed; a drive unit that generates a drive signal for driving the pixels; a charge pump circuit that generates electric power for driving the drive unit; and a control unit that controls, according to an operation of the imaging unit, a driving capability of the charge pump circuit to drive the drive unit.

### BRIEF DESCRIPTION OF DRAWINGS

FIG. 1 is a block diagram illustrating a configuration of an example of electronic equipment applicable to embodiments in common.

FIG. 2 is a block diagram illustrating a configuration of an example of an imaging element applicable to the embodiments.

FIG. 3 is a circuit diagram illustrating a configuration of an example of a pixel applicable to the embodiments.

FIG. 4 is a circuit diagram illustrating a configuration of an example of a charge pump according to a first embodiment.

FIG. 5 is a block diagram illustrating, more in detail, a configuration of an example for selecting a frequency of a clock signal for driving the charge pump according to the first embodiment.

FIG. 6 is a sequence chart illustrating an example of a control operation for the charge pump according to the first embodiment.

FIG. 7 is a diagram for comparing control of the charge pump according to the first embodiment and control according to an existing technique.

FIG. 8 is a block diagram illustrating a configuration of an example for selecting a frequency of a clock signal for driving a charge pump according to a first modification of the first embodiment.

FIG. 9 is a block diagram illustrating a configuration of an example for selecting a frequency of a clock signal for driving a charge pump according to a second modification of the first embodiment.

FIG. 10 is a circuit diagram illustrating a configuration of an example of a pixel applicable to a third modification of the first embodiment.

FIG. 11 is a sequence chart illustrating an example of a control operation for a charge pump according to a third modification of the first embodiment.

FIG. 12 is a circuit diagram illustrating a configuration of an example of a pixel applicable to a sixth modification of the first embodiment.

FIG. 13 is a diagram schematically illustrating a configuration of an example of a charge pump according to a second embodiment.

FIG. 14 is a diagram schematically illustrating a configuration of an example of a charge pump according to a third embodiment.

FIG. 15 is a circuit diagram illustrating a configuration example of a capacity value variable circuit in the charge pump according to the third embodiment.

FIG. 16 is a schematic diagram illustrating a configuration of an example of an imaging element according to a fourth embodiment.

FIG. 17A is a diagram illustrating an example of allocation of units of the imaging element to first and second substrates applicable to the fourth embodiment.

FIG. 17B is a diagram illustrating an example of allocation of the units of the imaging element to the first and second substrates applicable to the fourth embodiment.

FIG. 18 is a diagram illustrating examples of use of the imaging elements according to the first embodiment and the modifications of the first embodiment and the second, third, and fourth embodiments.

FIG. 19 is a block diagram illustrating a schematic configuration example of a vehicle control system, which is an example of a mobile body control system to which a technique according to the present disclosure can be applied.

FIG. 20 is a diagram illustrating an example of a setting position of an imaging unit.

### DESCRIPTION OF EMBODIMENTS

Embodiments of the present disclosure are explained in detail below with reference to the drawings. Note that, in the embodiments explained below, redundant explanation is omitted by denoting the same parts with the same reference numerals and signs.

Embodiments of the present disclosure are explained in detail below according to the following order.
1. Technique applicable to the embodiments
1-0-1. Drive example of the global shutter scheme
2. First Embodiment
2-0-1. More detailed description of the effects of the first embodiment
2-1. First modification of the first embodiment
2-2. Second modification of the first embodiment
2-3. Third modification of the first embodiment
2-4. Fourth modification of the first embodiment
2-5. Fifth modification of the first embodiment
2-6. Sixth modification of the first embodiment
2-7. Seventh modification of the first embodiment
3. Second Embodiment
4. Third Embodiment
5. Fourth Embodiment
6. Fifth Embodiment
6-1. More specific example of a case where the imaging element of the present disclosure is mounted on a vehicle

### 1. Technique Applicable to the Embodiments

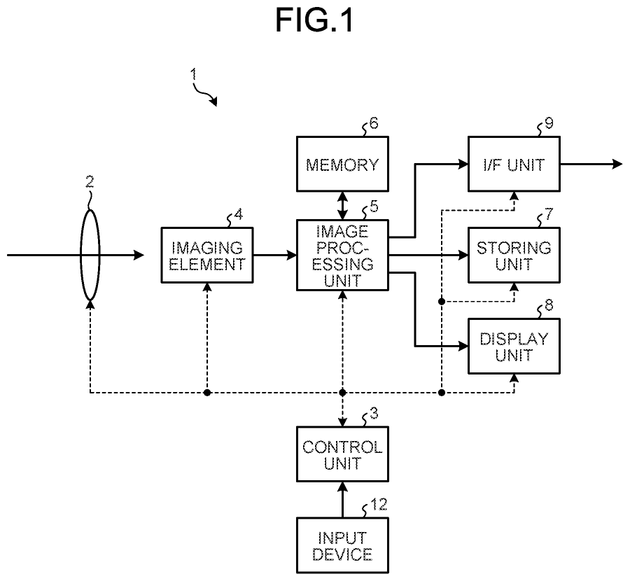

First, a technique applicable to the embodiments is explained. FIG. 1 is a block diagram illustrating a configuration of an example of electronic equipment applicable to the embodiments in common. In FIG. 1, electronic equipment 1 includes an optical system 2, a control unit 3, an imaging element 4, an image processing unit 5, a memory 6, a storing unit 7, a display unit 8, an interface (I/F) unit 9, and an input device 12.

Here, as the electronic equipment 1, a digital still camera, a digital video camera, a cellular phone with an imaging function, a smartphone, and the like can be applied. A monitoring camera, a vehicle-mounted camera, a medical camera, and the like can also be applied as the electronic equipment 1.

The imaging element 4 includes, for example, a plurality of photoelectric conversion elements arranged in a matrix array. The photoelectric conversion element converts received light into electric charges with photoelectric conversion. The imaging element 4 includes a drive circuit that drives the plurality of photoelectric conversion elements, a signal processing circuit that reads electric charges respectively from the plurality of photoelectric conversion elements and generates image data based on the read electric charges, and a power supply circuit for supplying power to the drive circuit.

The optical system 2 includes a main lens by a combination of one or a plurality of lenses and a mechanism for driving the main lens and forms an image of image light (incident light) from an object on a light receiving surface of the imaging element 4 via the main lens. The optical system 2 includes an autofocus mechanism that adjusts a focus according to a control signal and a zoom mechanism that changes a zoom ratio according to a control signal. The electronic equipment 1 may be configured such that the optical system 2 is detachably attachable and can be replaced with another optical system 2.

The image processing unit 5 executes predetermined image processing on image data output from the imaging element 4. For example, the image processing unit 5 is connected to the memory 6 by a frame memory or the like and writes the image data output from the imaging element 4 in the memory 6. The image processing unit 5 executes predetermined image processing on the image data written in the memory 6 and writes the image data subjected to the image processing in the memory 6 again.

The storing unit 7 is a nonvolatile memory such as a flash memory or a hard disk drive and stores the image data output from the image processing unit 5 in a nonvolatile manner. The display unit 8 includes a display device such as a liquid crystal display (LCD) and a drive circuit that drives the display device and can display an image based on the image data output by the image processing unit 5. The I/F unit 9 is an interface for transmitting the image data output from the image processing unit 5 to the outside. For example, a universal serial bus (USB) can be applied as the I/F unit 9. Not only this, but the I/F unit 9 may be an interface connectable to a network by wired communication or wireless communication.

The input device 12 includes an operator for receiving a user input. If the electronic equipment 1 is, for example, a digital still camera, a digital video camera, a cellular phone with an imaging function, or a smartphone, the input device 12 can include a shutter button for instructing imaging by the imaging element 4 or an operator for realizing the function of the shutter button.

The control unit 3 includes, for example, a processor such as a central processing unit (CPU), a read only memory (ROM), and a random access memory (RAM) and controls the entire operation of the electronic equipment 1 using the RAM as a work memory according to a program stored in the ROM in advance. For example, the control unit 3 can control the operation of the electronic equipment 1 according to the user input received by the input device 12. The control unit 3 can control the autofocus mechanism in the optical system 2 based on an image processing result of the image processing unit 5.

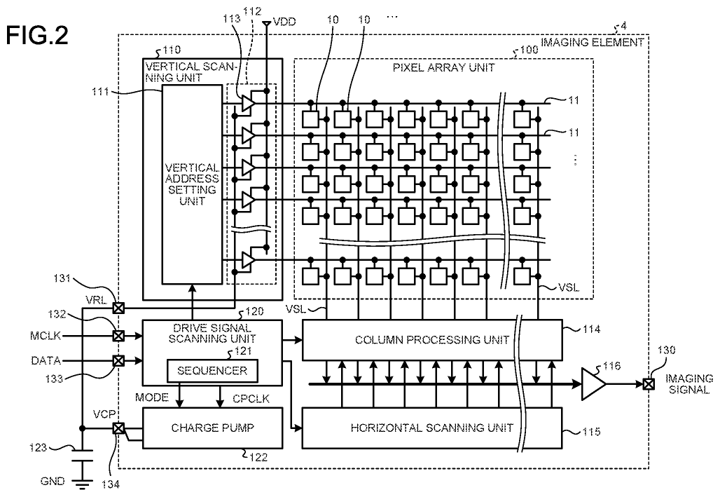

FIG. 2 is a block diagram illustrating a configuration of an example of the imaging element 4 applicable to the embodiments. In FIG. 2, the imaging element 4 schematically includes a pixel array unit 100, a vertical scanning unit 110, a column processing unit 114, a horizontal scanning unit 115, a drive signal scanning unit 120, and a charge pump 122.

Note that the imaging element 4 according to the first embodiment is a CMOS image sensor (CIS) in which the pixel array unit 100, the vertical scanning unit 110, the column processing unit 114, the horizontal scanning unit 115, the drive signal scanning unit 120, and the charge pump 122 are formed by a complementary metal oxide semiconductor (CMOS). In the imaging element 4 according to the first embodiment, the pixel array unit 100, the vertical scanning unit 110, the column processing unit 114, the horizontal scanning unit 115, the drive signal scanning unit 120, and the charge pump 122 are formed on one chip.

In the pixel array unit 100, pixels 10 including one or more photoelectric conversion elements are arranged in a matrix array. That is, the pixel array unit 100 is configured as an imaging unit in which the pixels 10 including photoelectric conversion elements as light receiving elements are arranged. Note that, in FIG. 2, an arrangement in the vertical direction is a column and an arrangement in the horizontal direction is a row. Rows are also referred to as lines. Columns are also referred to as columns. Pixel signal lines 11 are respectively connected to the pixels 10 for each of the rows. The pixel signal lines 11 are connected to the vertical scanning unit 110. Note that the pixel signal line 11 includes a plurality of signal lines.

The vertical scanning unit 110 includes a vertical address setting unit 111 and a vertical drive unit 112. The vertical address setting unit 111 selects the pixel signal line 11 to be driven from the pixel signal lines 11 according to a control signal supplied from the drive signal scanning unit 120 explained below. The vertical drive unit 112 includes amplifiers 113 for supplying a drive signal to the pixel signal lines 11 to correspond to the pixel signal lines 11. The amplifiers 113 are driven by a positive potential power supply VDD and a negative potential power supply VRL. The pixels 10 are driven row by row by a plurality of drive signals supplied from the vertical drive unit 112 via the amplifiers 113 and the pixel signal lines 11.

For example, the pixels 10 perform exposure for generating and accumulating electric charges corresponding to received light according to the drive signals. The pixels 10 output the electric charges accumulated by the exposure as pixel signals, which are electric signals, according to the drive signals. The vertical scanning unit 110 can simultaneously drive all the pixels 10 included in the pixel array unit 100 to an exposure state.

Vertical signal lines VSL are respectively connected to the pixels 10 for each of columns. The vertical signal lines VSL are connected to the column processing unit 114. The pixel signal read from the pixels 10 are supplied to the column processing unit 114 via the vertical signal lines VSL for each of columns.

The column processing unit 114 includes analog to digital (AD) conversion circuits connected to the vertical signal lines VSL in a one-to-one relation and converts the analog pixel signals supplied from the vertical signal lines into digital pixel signals according to the control by the drive signal scanning unit 120 explained below. The column processing unit 114 includes a signal processing circuit that applies predetermined signal processing such as correlated double sampling (CDS) processing for removing a noise component to the pixel signals supplied from the vertical signal lines VSL.

For example, as an AD converter, a single-slope AD converter that compares a pixel signal supplied from the pixel 10 via the vertical signal line VSL with a signal (referred to as a ramp signal RAMP), a voltage of which increases or decreases stepwise based on a straight line and performs AD conversion for the pixel signal can be applied. The AD converter generates two digital values by P-phase reading and D-phase reading explained below through AD conversion processing and executes the CDS processing explained above based on the two digital values. For example, the AD converter applies filter processing by a filter (referred to as a CDS filter) having a predetermined cutoff frequency to the two digital values and executes the CDS processing explained above.

The horizontal scanning unit 115 scans, in a row direction, the pixel signals processed by AD converters and signal processing circuits in the column processing unit 114 according to the control by the drive signal scanning unit 120. The scanned pixel signals are supplied to a bus and output from the bus to the outside of the imaging element 4 via a terminal 130 as an imaging signal via a buffer amplifier 116.

The drive signal scanning unit 120 includes a sequencer 121. The drive signal scanning unit 120 is supplied with a master clock MCLK and various data from the outside respectively via terminals 132 and 133. The sequencer 121 generates mode signals MODE each indicating an operation mode corresponding to each of the operations of the pixel array unit 100 based on the master clock MCLK and the data supplied to the drive signal scanning unit 120. The pixel array unit 100 is driven, based on a period indicated by an operation mode, to execute an operation corresponding to the operation mode.

The drive signal scanning unit 120 generates, based on the master clock MCLK and the operation mode, a control signal for controlling timing for the vertical address setting unit 111 to output the drive signals. The drive signal scanning unit 120 supplies the generated control signal to the vertical address setting unit 111.

The drive signal scanning unit 120 generates an operation clock CPCLK for driving the charge pump 122 explained below based on the master clock MCLK and supplies the generated operation clock CPCLK to the charge pump 122. The drive signal scanning unit 120 supplies mode signals MODE generated by the sequencer 121 to the charge pump 122.

As explained in detail below, the charge pump 122 includes a pumping capacitor and a switch circuit. The charge pump 122 schematically charges and boosts the pumping capacitor with a pumping operation corresponding to control of the switch circuit based on the operation clock CPCLK and outputs a boosted voltage VCP. The voltage VCP is once output from the imaging element 4 via a terminal 134, smoothed by a capacitor 123, and supplied from the terminal 131 to the imaging element 4 as the negative potential power supply VRL for driving the vertical drive unit 112 explained above.

As explained above, the vertical drive unit 112 functions as a drive unit that generates a drive signal for driving the pixels 10 included in the pixel array unit 100. The charge pump 122 generates electric power for driving the vertical drive unit 112. The drive signal scanning unit 120 functions as a control unit that controls, according to the operation of the pixel array unit 100, a driving capability of the charge pump 122 to drive the vertical drive unit 112.

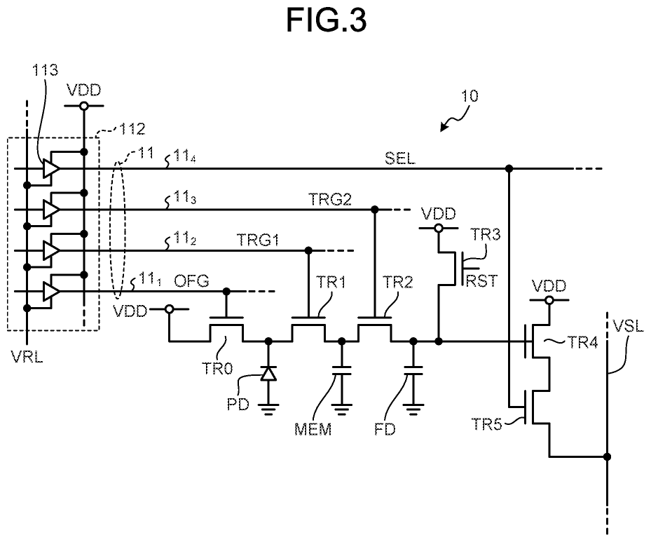

Subsequently, a configuration of the pixel 10 applicable to the first embodiment is explained. FIG. 3 is a circuit diagram illustrating a configuration of an example of the pixel 10 applicable to the embodiments. The configuration of the pixel 10 illustrated in FIG. 3 is an example corresponding to the global shutter scheme in which all the pixels 10 included in the pixel array unit 100 are simultaneously driven to the exposure state.

In FIG. 3, in the vertical drive unit 112, a portion corresponding to one row of the matrix array in the pixel array unit 100 in the vertical drive unit 112 illustrated in FIG. 2 is extracted and illustrated. In the example illustrated in FIG. 3, the pixel signal line 11 corresponding to one row includes four signal lines 11₁ to 11₄ for respectively supplying drive signals OFG, TRG1, TRG2, and SEL. The vertical drive unit 112 includes four amplifiers 113 corresponding to the four signal lines in a one-to-one relation. The amplifiers 113 are driven by the positive voltage power supply VDD and the negative voltage power supply VRL supplied from the charge pump 122.

Note that, although not illustrated in FIG. 3, the pixel signal line 11 further includes a signal line for supplying a drive signal RST. The vertical drive unit 112 further includes a component for outputting the drive signal RST.

The pixel 10 includes, for example, a PN-junction photodiode PD as the photoelectric conversion element. The pixel 10 is configured by a complementary metal oxide semiconductor (CMOS) circuit and includes an overflow gate (OFG) transistor TR0, transfer transistors TR1 and TR2, a reset transistor TR3, an amplification transistor TR4, and a read path selection transistor TR5, which are respectively N-type metal oxide semiconductor (MOS) transistors.

In the pixel 10, a cathode of the photodiode PD is connected to a connection point where a source of the overflow gate (OFG) transistor TR0 and a source of the transfer transistor TR1 are connected. A drain of the OFG transistor TR0 is connected to a power supply line of the positive voltage power supply VDD. A drain of the transfer transistor TR1 is connected to a connection point where a capacitor MEM and a source of the transfer transistor TR2 are connected.

The drive signal TRG1, which is, for example, a pulse, is supplied to a gate of the transfer transistor TR1 from the vertical drive unit 112 via the signal line 11₂. The drive signal OFG, which is, for example, a pulse, is supplied to a gate of the OFG transistor TR0 from the vertical drive unit 112 via the signal line 11₁. The transfer transistor TR1 and the OFG transistor TR0 are respectively turned on when the drive signals TRG1 and OFG are in a high state and are turned off when the transfer pulse TG is in a low state.

The drive signal TRG2, which is, for example, a pulse, is supplied to a gate of the transfer transistor TR2 via the signal line 11₃. The transfer transistor TR2 is turned on when the drive signal TRG2 is in the high state and is turned off when the drive signal TRG2 is in the low state.

Note that the drive signals OFG and TRG1 are simultaneously supplied to all the rows of the pixels 10 included in the pixel array unit 100. On the other hand, the transfer pulse TRG2 supplied to the transfer transistor TR2 is sequentially supplied for the rows.

A floating diffusion layer FD is connected to a connection point where a drain of the transfer transistor TR2 and a source of the reset transistor TR3 are connected. The power supply line of the positive voltage power supply VDD is connected to a drain of the reset transistor TR3. A drive signal RST, which is a pulse, is supplied to a gate of the reset transistor TR3 via a not-illustrated signal line. The reset transistor TR3 is turned on when the drive signal RST is in the high state and is turned off when the drive signal RST is in the low state.

A gate of the amplification transistor TR4 is connected to the floating diffusion layer FD. The power supply line of the power supply VDD is connected to a drain of the amplification transistor TR4 and a drain of the read path selection transistor TR5 is connected to a source of the amplification transistor TR4. A source of the read path selection transistor TR5 is connected to the vertical signal line VSL. The drive signal SEL is supplied to a gate of the read path selection transistor TR5 via the signal line 11₄. The read path selection transistor TR5 is turned on when the drive signal SEL is in the high state and is turned off when the drive signal SEL is in the low state.

### 1-0-1. Drive Example of the Global Shutter Scheme

In the configuration of the pixel 10 illustrated in FIG. 3, the exposure and reading operations are, for example, as follows.

At timing immediately before the exposure at the start of one frame period, the vertical scanning unit 110 simultaneously sets the drive signals OFG of the rows to the high state according to the control signal supplied from the drive signal scanning unit 120 and sets the OFG transistors TR0 included in all the pixels 10 in the pixel array unit 100 to an ON state. At this time, the drive signal TRG1 is set in the low state and the transfer transistor TR1 is set to an OFF state. Accordingly, in the pixels 10, electric charges accumulated in the photodiode PD are absorbed into the power supply line of the power supply VDD and the photodiode PD is initialized. When the drive signal OFG changes to the low state and the OFG transistor TR0 changes to the OFF state, exposure of the photodiode PD for one frame is started.

According to a control signal supplied from the drive signal scanning unit 120, the vertical scanning unit 110 sets the drive signal OFG to the low state and maintains the low state of the drive signal TRG1 during exposure. According to the control signal supplied from the drive signal scanning unit 120, the vertical scanning unit 110 sets the drive signal TRG2 to the low state and sets the drive signal RST to the high state during exposure, sets the transfer transistor TR2 to the OFF state, and sets the reset transistor TR3 to the ON state, and sucks out the electric charges of the floating diffusion layer FD to the power supply line of the power supply VDD to initialize the floating diffusion layer FD. Further, by setting the drive signal SEL to the high state, a signal by a voltage in a reset level of the floating diffusion layer FD is output to the vertical signal line VSL. This signal is a signal including offset noise. Reading of this signal from the floating diffusion layer FD is referred to as P-phase (Pre-Charge) reading and a period in which the P-phase reading is performed is referred to as a P-phase period.

Thereafter, according to a control signal supplied from the drive signal scanning unit 120, the vertical scanning unit 110 sets the drive signal RST to the low state to set the reset transistor TR3 to the OFF state and sets the drive signal TRG2 to the high state to set the transfer transistor TR2 to the ON state. The vertical scanning unit 110 sets the drive signal TRG1 to the low state to set the transfer transistor TR1 to the OFF state and separates the capacitor MEM and the photodiode PD. Accordingly, for example, reading processing for the electric charges accumulated in the capacitor MEM in the immediately preceding frame period is executed. The electric charges read from the capacitor MEM are accumulated in the floating diffusion layer FD.

According to a control signal supplied from the drive signal scanning unit 120, the vertical scanning unit 110 sets the drive signal TRG2 to the low state, sets the drive signal SEL to the high state, sets the transfer transistor TR2 to the OFF state, and sets the read path selection transistor TR5 to the ON state at timing when the accumulation of the electric charges in the floating diffusion layer FD is completed. Accordingly, a signal obtained by converting the electric charges accumulated from the floating diffusion layer FD into a voltage is read out, amplified by the amplification transistor TR4, and output to the vertical signal line VSL via the read path selection transistor TR5. This signal is a signal including offset noise and a pixel signal. Reading of this signal is referred to as D-phase (Data Phase) reading and a period in which the D-phase reading is performed is referred to as a D-phase period.

The reading processing for all the rows of the pixel array unit 100 is completed within one frame period.

When the exposure of the photodiode PD ends, the vertical scanning unit 110 sets the drive signal TRG2 to the low state to set the transfer transistor TR2 to the OFF state and sets the drive signal TRG1 to the high state to set the transfer transistor TR1 to the ON state according to a control signal supplied from the drive signal scanning unit 120. Accordingly, the electric charges accumulated in the photodiode PD by the exposure are transferred to the capacitor MEM. The transferred electric charges are accumulated in the capacitor MEM. According to a control signal supplied from the drive signal scanning unit 120, the vertical scanning unit 110 sets the drive signal TRG1 to the low state at timing when the accumulation of the electric charges in the capacitor MEM is completed.

In the next frame period, the vertical scanning unit 110 sets the drive signal OFG to the high state and sets the drive signal TRG1 to the low state according to a control signal supplied from the drive signal scanning unit 120 and executes initialization processing for the electric charges accumulated in the photodiode PD by the exposure in the immediately preceding frame. According to a control signal supplied from the drive signal scanning unit 120, the vertical scanning unit 110 sets the drive signal OFG to the low state at timing when the initialization processing ends and exposure is started. The drive signal TRG1 is maintained in the low state during the exposure.

As explained above, by using the OFG transistor TR0, the transfer transistor TR1, and the capacitor MEM, it is possible to realize a global shutter that executes exposure in the pixels 10 included in the pixel array unit 100 all at once.

### 2. First Embodiment

Subsequently, a first embodiment of the present disclosure is explained. In the first embodiment, a frequency of a clock signal for controlling the pumping operation in the charge pump 122 is switched based on an operation mode of the pixel array unit 100. This makes it possible to suppress power consumption in the charge pump 122.

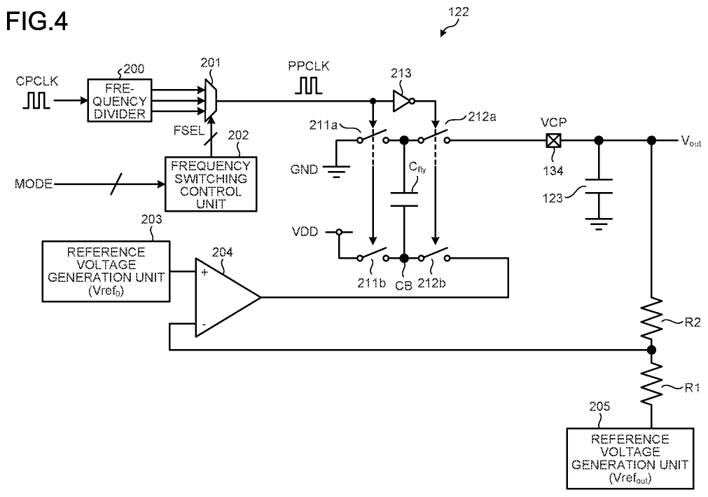

FIG. 4 is a circuit diagram illustrating a configuration of an example of the charge pump 122 according to the first embodiment. In FIG. 4, the charge pump 122 includes a reference voltage generation unit 203, an amplifier 204, a reference voltage generation unit 205, voltage-dividing resistors R1 and R2, a capacitor C_{fly} used as a pumping capacitor, switch circuits 211a, 211b, 212a, and 212b, and an inverter 213. Further, the charge pump 122 includes a frequency divider 200, a selector 201, and a frequency switching control unit 202. The frequency divider 200, the selector 201, and the frequency switching control unit 202 function as a clock generation unit that generates a clock signal for driving the charge pump 122.

The frequency divider 200 divides a clock signal CPCLK supplied from the drive signal scanning unit 120 and generates a plurality of clock signals having different frequencies. Note that, instead of the frequency divider 200, a multiplier that outputs a signal having a frequency of, for example, an integral multiple of the frequency of the input signal may be used. The plurality of clock signals output from the frequency divider 200 is input to the selector 201.

Mode signals MODE output from the sequencer 121 of the drive signal scanning unit 120 is input to the frequency switching control unit 202. The frequency switching control unit 202 generates a frequency switching signal FSEL based on a combination of the mode signals. According to the frequency switching signal FSEL, the selector 201 selects one clock signal from a plurality of clock signals input from the frequency divider 200 and outputs the selected clock signal as a clock signal PPCLK for controlling the pumping operation in the charge pump 122 and driving the charge pump 122.

A frequency of the clock signal PPCLK greatly affects a driving capability of the charge pump 122 to drive the vertical drive unit 112. For example, as the frequency of the clock signal PPCLK is higher, charging and discharging for the capacitor C_{fly} are performed at higher speed and the driving capability by the charge pump 122 increases.

On the other hand, in FIG. 4, one end of the switch circuit 211a is connected to the ground potential and the other end is connected to one end of the switch circuit 212a. The other end of the switch circuit 212a is connected to one end of the capacitor 123 and one end of the voltage-dividing resistor R2 via the terminal 134. The other end of the voltage-dividing resistor R2 is connected to one end of the voltage-dividing resistor R1. The other end of the voltage-dividing resistor R1 is connected to an output of the reference voltage generation unit 20₅. A connection point of the voltage-dividing resistors R1 and R2 is connected to a (−) input end of the amplifier 204.

An output voltage Vₒᵤₜ of the charge pump 122 is extracted from the other end of the switch circuit 212a. One end of the switch circuit 211b is connected to the power supply line of the positive voltage power supply VDD and the other end is connected to one end of the switch circuit 212b. The other end of the switch circuit 212b is connected to the output of the amplifier 204.

A reference voltage Vref₀ generated by the reference voltage generation unit 203 is input to a (+) input end of the amplifier 204. A voltage (referred to as a divided voltage) obtained by dividing a reference voltage Vrefₒᵤₜ generated by the reference voltage generation unit 205 by the voltage-dividing resistors R1 and R2 with respect to the output voltage Vₒᵤₜ is input to the (−) input end of the amplifier 204. The amplifier 204 outputs a difference between the reference voltage Vref₀ input to the (+) input end and the divided voltage input to the (−) input end.

One end of the capacitor C_{fly} functioning as a pumping capacitor is connected to a connection point where the other end of the switch circuit 211a and one end of the switch circuit 212a are connected. The other end of the capacitor C_{fly} is connected to a connection point CB where the other end of the switch circuit 211b and one end of the switch circuit 212b are connected.

The switch circuits 211a and 211b and the switch circuits 212a and 212b are respectively controlled to open and close according to the clock signal PPCLK output from the selector 201. Open and close states of the switch circuits 211a and 211b are controlled to be the same according to the clock signal PPCLK before being input to the inverter 213. Open and close states of the switch circuits 212a and 212b are controlled to be the same according to the clock signal PPCLK input via the inverter 213. That is, the operations of the switch circuits 211a and 211b and the switch circuits 212a and 212b are controlled exclusively from each other. For example, when the clock signal PPCLK is in the high state, the switch circuits 211a and 211b are in the ON state and the switch circuits 212a and 212b are in the OFF state and, when the clock signal PPCLK is in the low state, the switch circuits 211a and 211b are in the OFF state and the switch circuits 212a and 212b are in the ON state.

With the switch circuits 211a and 211b are in the ON state and the switch circuits 212a and 212b in the OFF state, electric charges are charged in the capacitor C_{fly}. When the switch circuits 211a and 211b are in the OFF state and the switch circuits 212a and 212b are in the ON state, a voltage corresponding to the electric charges charged in the capacitor C_{fly} is extracted from the other end of the switch circuit 212a. By repeating this operation, electric charges are accumulated in the capacitor C_{fly}, a voltage across the capacitor C_{fly} is boosted, and the voltage VCP is generated. The voltage VCP is smoothed by the capacitor 123 and output as the output voltage Vₒᵤₜ of the charge pump 122.

A difference between the output voltage Vₒᵤₜ of the charge pump 122 and the reference voltage Vrefₒᵤₜ generated by the reference voltage generation unit 205 is divided by the voltage-dividing resistors R1 and R2 and input to the (−) input end of the amplifier 204. In the charge pump 122 illustrated in FIG. 4, a feedback loop based on the output of the amplifier 204 is formed in this way. The charge pump 122 can stably output the output voltage Vₒᵤₜ.

Further, the charge pump 122 illustrated in FIG. 4 switches, based on the mode signals MODE indicating the operation mode of the pixel array unit 100, the frequency of the clock signal PPCLK for controlling the operations of the switch circuits 211a and 211b and the switch circuits 212a and 212b. Therefore, for example, the frequency of the clock signal PPCLK can be set to a low frequency in a period of an operation mode in which large power is not required in the vertical drive unit 112 and can be set to a high frequency in a period of an operation mode in which large power is instantaneously required (for example, at the time of simultaneous reset in the pixel array unit 100 of the photodiode PD). Power consumption of the charge pump 122 can be suppressed.

In the period of the operation mode in which large power is instantaneously required, the electric charges accumulated in the capacitor C_{fly} are suddenly discharged. Therefore, by setting the frequency of the clock signal PPCLK to a higher frequency in this period, the state of the capacitor C_{fly} can be restored in a shorter time.

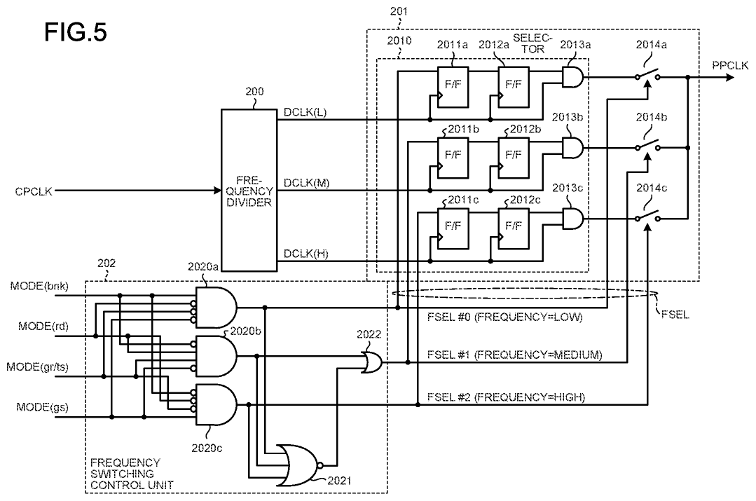

FIG. 5 is a block diagram illustrating, more in detail, a configuration of an example for selecting a frequency of the clock signal PPCLK for driving the charge pump 122 according to the first embodiment. In the example illustrated in FIG. 5, the frequency divider 200 generates, based on the clock signal CPCLK, three clock signals DCLK(L), DCLK(M), and DCLK(H) having different frequencies. Assuming that the frequency of the clock signal DCLK(M) is a reference (a medium frequency), a frequency of the clock signal DCLK(L) is lower than the frequency of the clock signal DCLK(M). The frequency of the clock signal DCLK(H) is higher than the frequency of the clock signal DCLK(M).

The configuration of the frequency divider 200 is not particularly limited if the configuration is a configuration for digitally performing frequency division. However, for example, a configuration including a general flip-flop circuit or a configuration including a counter circuit can be applied.

Note that, in the following explanation, when it is unnecessary to distinguish the clock signals DCLK(L), DCLK(M), and DCLK(H), these clock signals DCLK(L), DCLK(M), and DCLK(H) are collectively described as a clock signal DCLK as appropriate.

The frequency switching control unit 202 outputs the frequency switching signal FSEL for selecting one clock signal DCLK from the three clock signals DCLK(L), DCLK(M), and DCLK(H) according to the mode signals MODE explained below. The frequency switching control unit 202 includes four-input AND circuits 2020a, 2020b, and 2020c, a three-input NOR circuit 2021, and a two-input OR circuit 2022. In the example illustrated in FIG. 5, in the AND circuit 2020a, second to fourth input ends among the four inputs are set as inverted inputs, in the AND circuit 2020b, first and fourth input ends among the four inputs are set as inverted inputs, and in the AND circuit 2020c, first to third input ends are set as inverted inputs.

The mode signals MODE supplied to the frequency switching control unit 202 are four kinds, that is, a mode signal MODE(bk), a mode signal MODE(rd), a mode signal MODE (gr/ts), and a mode signal MODE(gs). The mode signal MODE(bk) indicates an operation mode in a blank period. The mode signal MODE(rd) indicates an operation mode in a read period. The mode signal MODE(gr/ts) indicates an operation mode in a global reset and transfer period. The mode signal MODE(gs) indicates an operation mode in a global shutter period. Details of the operation modes are explained below.

In FIG. 5, the mode signal MODE(bk) is input to first input ends of the respective AND circuits 2020a, 2020b, and 2020c. The mode signal MODE(rd) is input to second input ends of the respective AND circuits 2020a, 2020b, and 2020c. The mode signal MODE(gr/ts) is input to third input ends of the respective AND circuits 2020a, 2020b, and 2020c. The mode signal MODE(gs) is input to fourth input ends of the respective AND circuits 2020a, 2020b, and 2020c.

An output of the AND circuit 2020a is supplied to the selector 201 as a frequency switching signal FSEL #0 for selecting the clock signal DCLK(L) and is input to a first input end of the three-input NOR circuit 2021. An output of the AND circuit 2020b is input to a first input end of the two-input OR circuit 2022 and is input to a second input end of the NOR circuit 2021. An output of the AND circuit 2020c is supplied to the selector 201 as a frequency switching signal FSEL #2 for selecting the clock signal DCLK(H) and is input to a third input end of the three-input NOR circuit 2021. An output of the NOR circuit 2021 is input to a second input end of the OR circuit 2022. An output of the OR circuit 2022 is supplied to the selector 201 as a frequency switching signal FSEL #1 for selecting the clock signal DCLK(M).

Table 1 illustrates an example of a truth table in the frequency switching control unit 202 illustrated in FIG. 5.

TABLE 1

| | Mode signals MODE | | | | | | | |
|---|---|---|---|---|---|---|---|---|
| | MODE | MODE | MODE | MODE | | | | |
| Mode | (bk) | (rd) | (gr/ts) | (gs) | FSEL#2 | FSEL#1 | FSEL#0 | Frequency |
| Blank | H | L | L | L | L | L | H | Low |
| Read | L | H | L | L | L | H | L | Medium |
| Global reset/ | L | L | H | L | H | L | L | High |
| transfer | | | | | | | | |
| Global | L | H | L | H | H | L | L | High |
| shutter | | | | | | | | |

| | | | | | |
|---|---|---|---|---|---|
| — | Other than the above | L | L | H | Low |

In Table 1, rows correspond to the operation modes of the pixel array unit 100 and indicate the operation modes of blank, read, global reset and transfer, and global shutter from the top.

A period in which the operation mode is blank (hereinafter referred to as blank period) is, for example, an operation mode period in which the AD converter included in the column processing unit 114 is not operating. Processing such as transfer of an imaging signal to the outside of the imaging element 4 is allocated to the operation mode period. In the blank period, read processing from the pixels 10 and the like are not performed and access to transistors included in the pixels 10 is not performed.

A period in which the operation mode is read (hereinafter referred to as read period) is an operation mode period in which read processing for reading a pixel signal from the pixels 10 is executed and access to the transistors included in the pixels 10 is performed. More specifically, in the read period, the transfer transistor TR2 set to the ON state and the transfer transistor TR1 is set to the OFF state and electric charges are transferred from the capacitor MEM to the floating diffusion layer FD. The electric charges transferred to the floating diffusion layer FD are converted into a voltage by the amplification transistor TR4. Further, in the read period, the read path selection transistor TR5 is set to the ON state. The voltage obtained by converting the electric charges with the amplification transistor TR4 is output to the vertical signal line VSL as a pixel signal. Furthermore, in the read period, the column processing unit 114 converts the pixel signal for each row supplied via the vertical signal line VSL into an imaging signal.

A period (hereinafter referred to as global reset and transfer period) in which the operation mode is the global reset and transfer is an operation mode period in which a reset operation for the floating diffusion layer FD, the capacitor MEM, and the photodiode PD for the pixels 10 is executed. Access to the transistors included in the pixels 10 is performed. More specifically, in the global reset and transfer period, the transfer transistor TR2 and the reset transistor TR3 are set to the ON state and the transfer transistor TR1 is set to the OFF state and the capacitor MEM and the floating diffusion layer FD are reset. Thereafter, the transfer transistor TR2 and the reset transistor TR3 are switched from an OFF normal state to the ON state, the transfer transistor TR1 is switched from the OFF state to the ON state. The electric charges accumulated in the photodiode PD by exposure are transferred to the capacitor MEM. Thereafter, the OFG transistor TR0 is switched from the OFF state to the ON state to reset the photodiode PD (close the shutter).

A period (hereinafter referred to as global shutter period) in which the operation mode is the global shutter is an operation mode period in which the exposure is started (the shutter is opened) in the pixels 10 included in the pixel array unit 100 all at once. Access to the transistors included in the pixel 10 is performed. More specifically, in the global shutter period, the OFG transistor TR0 is switched from the ON state to the OFF state to start exposure.

Referring back to Table 1, in Table 1, first to fourth columns from the left respectively indicate states of the mode signals MODE(br), MODE(rd), MODE(gr/ts), and MODE(gs) for the respective operation modes. In Table 1, “L” indicates a low state of a signal and “H” indicates a high state of the signal. Fifth to seventh columns from the left respectively indicate states of the frequency switching signals FSEL #2, FSEL #1, and FSEL #0 for switching to the clock signals DCLK(H), DCLK(M), and DCLK(L).

In the blank period, as explained above, there is no access to the transistors included in the pixel 10. Therefore, power consumption in the pixels 10 is small and power consumption of the pixel array unit 100 as a whole is also small. Therefore, logic is configured such that the charge pump 122 can be driven at the low frequency and a frequency of the clock signal PPCLK for controlling the pumping operation in the charge pump 122 is the low frequency.

For example, in Table 1, in the blank period, the mode signals MODE(bk), MODE(rd), MODE(gr/ts), and MODE(gs) are respectively set to the states of “H”, “L”, “L”, and “L”. In the states of the mode signals MODE(bk), MODE(rd), MODE(gr/ts), and MODE(gs), logic is configured such that the frequency switching signals FSEL #2, FSEL #1, and FSEL #0 respectively become “L”, “L”, and “H”, the frequency switching signal FSEL #0 is enabled, and the clock signal DCLK(L) having the lowest frequency is selected.

In the read period, access to the transistors included in the pixel 10 is included. However, the access is by an operation for outputting a pixel signal read in the pixels 10 to the vertical signal line VSL. Therefore, the access is performed for each row and does not occur at the same time in the pixels 10 included in the pixel array unit 100. Therefore, the power consumption of the entire pixel array unit 100 does not increase at certain timing. Therefore, logic is configured such that the charge pump 122 can be driven at a normal (medium) frequency and a frequency of the clock signal PPCLK for controlling the pumping operation in the charge pump 122 is the normal (medium) frequency.

For example, in Table 1, during the read period, the mode signals MODE(bk), MODE(rd), MODE(gr/ts), and MODE(gs) are respectively set to the states of “L”, “H”, “L”, and “L”. In the states of the mode signals MODE(bk), MODE(rd), MODE(gr/ts), and MODE(gs), logic is configured such that the frequency switching signals FSEL #0, FSEL #1, and FSEL #2 respectively become “L”, “H”, and “L”, the frequency switching signal FSEL #1 is enabled, and the clock signal DCLK(M) having the medium frequency is selected.

In the global reset and transfer period and the global shutter period, access to the transistors included in the pixel 10 is included. In these periods, access to the transistors included in the pixel 10 is included. The access includes access simultaneously executed in the pixels 10 included in the pixel array unit 100. Therefore, the power consumption of the entire pixel array unit 100 instantaneously increases at timing of the access. In this case, it is desirable that the electric charges accumulated in the capacitor C_{fly} of the charge pump 122 are instantaneously discharged, and a charge amount of the capacitor C_{fly} is recovered in a short time. Therefore, in this global reset and transfer period, logic is configured such that a frequency of the clock signal PPCLK for controlling the pumping operation in the charge pump 122 is the high frequency.

For example, in Table 1, in the global reset and transfer period, the mode signals MODE(bk), MODE(rd), MODE(gr/ts), and MODE(gs) are respectively set to the states of “L”, “L”, “H”, and “L”. In the states of the mode signals MODE(bk), MODE(rd), MODE(gr/ts), and MODE(gs), logic is configured such that the frequency switching signals FSEL #0, FSEL #1, and FSEL #2 respectively become “H”, “L”, and “L”, the frequency switching signal FSEL #2 is enabled, and the clock signal DCLK(H) having the highest frequency is selected.

Similarly, when the operation mode is the global shutter period, the mode signals MODE(bk), MODE(rd), MODE(gr/ts), and MODE(gs) are respectively set to the states of “L”, “H”, “L”, and “H”. In the states of the mode signals MODE(bk), MODE(rd), MODE(gr/ts), and MODE(gs), logic is configured such that the frequency switching signals FSEL #0, FSEL #1, and FSEL #2 respectively become “H”, “L”, and “L”, the frequency switching signal FSEL #2 is enabled, and the clock signal DCLK(H) having the highest frequency is selected.

Note that, when the operation mode is other than the operation modes explained above and a combination of the mode signals MODE(bk), MODE(rd), MODE(gr/ts), and MODE(gs) is other than the combinations explained above, the frequency of the clock signal PPCLK is set to the low frequency. In the example illustrated in Table 1, in this case, logic is configured such that the frequency switching signals FSEL #2, FSEL #1, and FSEL #0 respectively become “L”, “L”, and “H”, the frequency switching signal FSEL #0 is enabled, and the clock signal DCLK(L) having the lowest frequency is selected.

The logic by the frequency switching control unit 202 illustrated in FIG. 5 is an example of logic configured based on the states illustrated in Table 1.

Note that the truth table illustrated in Table 1 is an example and is not limited to this example. FIG. 4 illustrates a circuit of the frequency switching control unit 202 configured based on the truth table of Table 1. However, this is an example. The circuit is not limited to this example. That is, the circuit of the frequency switching control unit 202 may be a circuit configuration other than the circuit configuration illustrated in FIG. 4 if the frequency switching signals FSEL #0 to #2 are switched by the mode signals MODE(bk), MODE(rd), MODE(gr/ts), and MODE(gs) and the clock signal PPCLK for controlling the pumping operation can be changed to a predetermined signal.

In the above explanation, three stages of the low frequency, the medium frequency, and the high frequency can be selected as the clock signal PPCLK. However, this is an example. The clock signal PPCLK is not limited to this example. For example, the frequency of the clock signal PPCLK can be finely controlled by four or more stages of resolution.

Returning back to FIG. 5, the selector 201 includes a synchronization circuit 2010 and switch circuits 2014a, 2014b, and 2014c.

The synchronization circuit 2010 is a circuit that synchronizes the clock signals DCLK(L), DCLK(M), and DCLK(H) supplied from the frequency divider 200 and the frequency switching signals FSEL #0, #1, and #2 supplied from the frequency switching control unit 202. The synchronization circuit 2010 includes three synchronization circuits corresponding to the clock signals DCLK(L), DCLK(M), and DCLK(H).

In the example illustrated in FIG. 5, a synchronization circuit including two flip-flop (F/F) circuits 2011a and 2012a connected in series and an AND circuit 2013a is configured for the clock signal DCLK(L). A synchronization circuit including two flip-flop circuits 2011b and 2012b connected in series and an AND circuit 2013b is configured for the clock signal DCLK(M). Similarly, a synchronization circuit including two flip-flop circuits 2011c and 2012c connected in series and an AND circuit 2013c is configured for the clock signal DCLK (H).

Since these three synchronization circuits exhibit similar operations, the synchronization circuit corresponding to the clock signal DCLK(L) is explained as an example. The clock signal DCLK(L) is input to clock input ends of the flip-flop circuits 2011a and 2012a and one input end of the AND circuit 2013a. The frequency switching signal FSEL #0 is input to a data input end of the flip-flop circuit 2011a. An output from a non-inverting output end of the flip-flop circuit 2011a is input to a data input end of the flip-flop circuit 2012a. An output from the non-inverting output end of the flip-flop circuit 2012a is input to the other input end of the AND circuit 2013a.

With such a configuration, in the flip-flop circuit 2011a, a rising edge of the frequency switching signal FSEL #0 is synchronized with a rising edge of the clock signal DCLK(L). An output of the flip-flop circuit 2011a is further synchronized with the clock signal DCLK(L) by the next flip-flop circuit 2012a. As explained above, by using the flip-flop circuits 2011a and 2012a connected in series, the reliability of synchronization can be further improved.

The AND circuit 2013a calculates AND of the output of the flip-flop circuit 2012a and the clock signal DCLK(L), whereby the clock signal DCLK(L) synchronized with the frequency switching signal FSEL #0 is output from the AND circuit 2013a.

About the clock signals DCLK(M) and DCLK(H), similarly to the clock signal DCLK(L) explained above, the clock signals DCLK(M) and DCLK(H) synchronized with the frequency switching signals FSEL #1 and #2 are respectively output from the AND circuits 2013b and 2013c.

The clock signals DCLK(L), DCLK(M), and DCLK(H) output from the AND circuits 2013a, 2013b, and 2013c are respectively input to the switch circuits 2014a, 2014b, and 2014c. Outputs of the switch circuits 2014a, 2014b, and 2014c are connected to be a common output. The switch circuits 2014a, 2014b, and 2014c are respectively controlled to be opened and closed by the frequency switching signals FSEL #0, #1, and #2. Therefore, the clock signals DCLK(L), DCLK(M), and DCLK(H) are output from the selector 201 when the frequency switching signals FSEL #0, #1, and #2 are in the high state.

According to Table 1 explained above, in the operation modes, only one of the frequency switching signals FSEL #0, #1, and #2 is set to the high state. For example, in a period of the operation mode in which the operation mode is blank, only the frequency switching signal FSEL #0 of the frequency switching signals FSEL #0 to #2 is in set to the high state, only the switch circuit 2014a is set to the closed (ON) state, and the switch circuits 2014b and 2014c are set to the open (OFF) state. Accordingly, only the clock signal DCLK(L) among the clock signals DCLK(L), DCLK(M), and DCLK(H) is output from the selector 201 as the clock signal PPCLK.

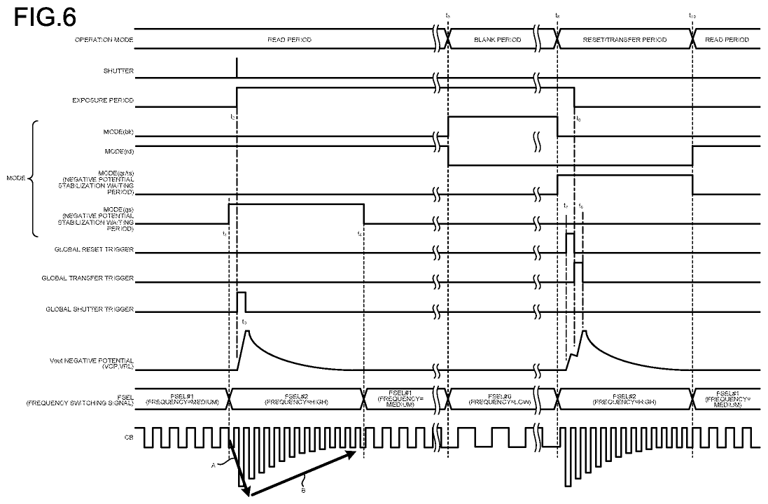

FIG. 6 is a sequence chart illustrating an example of a control operation of the charge pump 122 according to the first embodiment. Note that, in FIG. 6, elapse of time is illustrated in the right direction and signals and timings of an operation mode, a shutter instruction, an exposure period, the mode signals MODE(br), MODE(rd), MODE(gr/ts), and MODE(gs), a global reset trigger, a global transfer trigger, a global shutter trigger, the output voltage Vₒᵤₜ by negative potential of the charge pump 122, the frequency switching signal FSEL, and a voltage (for convenience, referred to as a voltage CB) at the connection point CB (see FIG. 4) to which the other end of the capacitor C_{fly} is connected in the charge pump 122 are illustrated in the vertical direction from the top.

Note that, in FIG. 6, among control operations in the pixel array unit 100, control operations relating to the entire pixel array unit 100 are extracted and illustrated. For example, operations executed for each row of the pixel array unit 100 are omitted.

Among these, the operation mode indicates operation mode periods of the blank, the read, the global reset and transfer, and the global shutter explained above. The operation modes are defined according to the mode signals MODE(br), MODE(rd), MODE(gr/ts), and MODE(gs) or a combination thereof in an operation period of the pixel array unit 100.

The shutter instruction is, for example, a signal that changes to the high state at timing corresponding to shutter operation on the input device 12 by a user. At this time, the shutter instruction is issued, for example, at a point in time when a state of the shutter button included in the input device 12 changes from a half-pressed state to a full-pressed state. Not only this, but the shutter instruction may be issued with a slight delay with respect to the shutter operation on the input device 12. In the case of moving image imaging, the shutter instruction is, for example, a signal that changes to the high state at predetermined timing of a frame period.

The exposure period is a period in which electric charges are accumulated by photoelectric conversion in the photodiode PD and is, for example, a period in which the OFG transistor TR0 and the transfer transistor TR1 are in the OFF state after the initialization of the photodiode PD.

As explained above, the mode signal MODE(br) is a signal indicating the blank period and is, more specifically, a flag signal indicating the blank period. In the example illustrated in FIG. 6, a period in which the mode signal MODE(br) is in the high state is the blank period. As explained above, the mode signal MODE(rd) is a signal indicating the read period and is, more specifically, a flag signal indicating the read period. In the example illustrated in FIG. 6, a period in which the mode signal MODE(rd) is in the high state is the read period.

As explained above, the mode signal MODE(gr/ts) is a signal indicating the global reset and the transfer period and is, more specifically, a flag signal indicating the global reset and transfer period. In the example illustrated in FIG. 6, a period in which the mode signal MODE(gr/ts) is in the high state is the global reset and transfer period. The mode signal MODE(gr/ts) indicates a negative potential stabilization waiting period for waiting for stabilization of the output voltage Vₒᵤₜ of the negative potential of the charge pump 122 that has fluctuated because of the global reset and the transfer operation.

As explained above, the mode signal MODE(gs) is a signal indicating the global shutter period and is, more specifically, a flag signal indicating the global shutter period. The mode signal MODE(gs) indicates a negative potential stabilization waiting period for waiting for stabilization of the output voltage Vₒᵤₜ of the negative potential of the charge pump 122 that has fluctuated because of the global shutter operation.

The global reset trigger is a trigger generated by, for example, the drive signal scanning unit 120 in order to execute initialization of the capacitors MEM and the floating diffusion layers FD included in the pixels 10 in the entire pixel array unit 100 all at once. The vertical drive unit 112 causes states of the drive signals TRG2 and RST to transition according to the global reset trigger.

The global transfer trigger is, for example, a trigger generated by the drive signal scanning unit 120 in order to execute transfer of electric charges accumulated in the photodiodes PD by the exposure in the pixels 10 to the capacitors MEM in the entire pixel array unit 100 all at once. The vertical drive unit 112 causes a state of the drive signal TRG1 to transition according to the global transfer trigger. The global shutter trigger is, for example, a trigger generated by the drive signal scanning unit 120 in order to instruct a start of exposure in the photodiodes PD. The vertical drive unit 112 causes a state of the drive signal OFG to transition according to the global shutter trigger.

The output voltage Vₒᵤₜ is an output voltage output from the charge pump 122. A signal by the output voltage Vₒᵤₜ is a signal obtained by smoothing, with the capacitor 123, a signal including a frequency component corresponding to the pumping operation output from the capacitor C_{fly}. Here, the voltage CB at the connection point CB to which the other end of the capacitor C_{fly} is connected is the signal including the frequency component corresponding to the pumping operation of the capacitor C_{fly}. In FIG. 6, this voltage CB is schematically illustrated as a rectangular wave. The voltage CB corresponds to the voltage across the capacitor C_{fly}. A change in the output voltage Vₒᵤₜ relates to a change in the voltage CB.

In the frequency switching signal FSEL, the frequency switching signal FSEL #0 corresponding to the clock signal DCLK(L) having the low frequency, the frequency switching signal FSEL #1 corresponding to the clock signal DCLK(M) having the medium frequency, and the frequency switching signal FSEL #2 corresponding to the clock signal DCLK(H) having the high frequency are illustrated to correspond to periods in which the frequency switching signal FSEL #0, the frequency switching signal FSEL #1, and the frequency switching signal FSEL #2 are effective during the operation period of the pixel array unit 100.

In FIG. 6, the operation mode is read from the left end side. The drive signal scanning unit 120 sets the mode signal MODE(rd) to the high state and sets the mode signals MODE(br), MODE(gr/ts), and MODE(gs) to the low state. Accordingly, the frequency switching control unit 202 outputs the frequency switching signal FSEL #1 and the selector 201 outputs the clock signal DCLK(M) having the medium frequency as the clock signal PPCLK. The drive signal scanning unit 120 sets the global reset trigger, the global transfer trigger, and the global shutter trigger to the low state.

The drive signal scanning unit 120 causes the mode signal MODE(gs) to transition from the low state to the high state at time t₁ immediately before a shutter instruction is issued at time t₂. For example, the drive signal scanning unit 120 sets timing when the full-press operation of the shutter is performed in the input device 12 as the time t₁ and starts exposure at the time t₂ after a predetermined time from the time t₁.

At the time t₁, when the mode signal MODE(gs) transitions to the high state, the frequency switching control unit 202 switches the frequency switching signal from the frequency switching signal FSEL #1 to the frequency switching signal FSEL #2 according to the truth table of Table 1. Accordingly, the clock signal DCLK(H) having a higher frequency is selected as the clock signal PPCLK.

At the time t₂, the vertical scanning unit 110 sets the global shutter trigger to the high state and sets the drive signal OFG to the high state according to control of the drive signal scanning unit 120. At this time, since the global transfer trigger is in the low state and the drive signal TRG1 is in the low state, the electric charges accumulated in the photodiode PD are extracted to the power supply line of the power supply VDD and the photodiode PD is initialized. The drive signal scanning unit 120 causes the global shutter trigger to transition from the high state to the low state at time t₃ in a state in which the low state of the drive signal TRG1 is maintained. The vertical drive unit 112 causes the drive signal OFG to transition from the high state to the low state according to the state transition of the global shutter trigger. Accordingly, accumulation of electric charges by photoelectric conversion is started in the photodiode PD and exposure is performed.

The transition of the drive signal OFG from the low state to the high state at the time t₂ is executed in the pixels 10 included in the pixel array unit 100 all at once. The potential of the output voltage Vₒᵤₜ of the charge pump 122 suddenly changes. By increasing the frequency of the clock signal PPCLK for operating the charge pump 122, the pumping operation in the charge pump 122 is executed at high speed and the capacitor C_{fly} is rapidly charged.

The drive signal scanning unit 120 causes the mode signal MODE(gs) to transition from the high state to the low state at time t₄ after a predetermined time from the time t₁. Note that, as the length from the time t₁ to the time t₄, a time in which it is predicted that the charging of the capacitor C_{fly} is completed in the charge pump 122 and the output voltage Vₒᵤₜ of the charge pump 122 stabilizes is set in advance for the drive signal scanning unit 120.

The mode signal MODE(gs) is caused to transition from the high state to the low state at the time t₄, whereby the frequency switching control unit 202 switches the frequency switching signal from the frequency switching signal FSEL #2 to the frequency switching signal FSEL #1 according to the truth table in Table 1. Accordingly, the clock signal DCLK(M) having a frequency lower than that of the clock signal DCLK(H) is selected as the clock signal PPCLK for operating the charge pump 122.

The drive signal scanning unit 120 causes the mode signal MODE(bk) to transition from the low state to the high state at time t₅ after a predetermined time from the time t₄ and causes the mode signal MODE(rd) to transition from the high state to the low state. Accordingly, the frequency switching control unit 202 switches the frequency switching signal from the frequency switching signal FSEL #1 to the frequency switching signal FSEL #0 according to the truth table of Table 1. The clock signal DCLK(L) having the lowest frequency is selected as the clock signal PPCLK.

The operation mode of the pixel array unit 100 is caused to transition from read to blank at the time t₅. Processing such as transfer of an imaging signal to the outside of the imaging element 4 is executed in the pixel array unit 100. As explained above, in the period in which the operation mode is blank, the read processing from the pixels 10 and the like are not performed and access to the transistors included in the pixel 10 is not performed. Therefore, the power consumption in the vertical drive unit 112 of the pixel array unit 100 is also small. There is no rapid fluctuation in a charge amount in the capacitor C_{fly} in the charge pump 122. Therefore, the charge pump 122 can operate with the clock signal PPCLK having the low frequency.

At time t₆ after a predetermined time elapses from the time t₅, the drive signal scanning unit 120 causes the mode signal MODE(bk) to transition from the high state to the low state and ends the blank period. The drive signal scanning unit 120 causes the mode signal MODE(gr/ts) to transition from the low state to the high state at the time t₆. Accordingly, the operation mode of the pixel array unit 100 is switched to the global reset and transfer mode.

The drive signal scanning unit 120 causes the global reset trigger to transition from the low state to the high state at time t₇. The vertical drive unit 112 causes the drive signals TRG2 and RST to transition from the low state to the high state according to the state transition of the global reset trigger of the drive signal scanning unit 120 and sets the transfer transistor TR2 and the reset transistor TR3 to the ON state. Accordingly, the electric charges of the capacitor MEM and the floating diffusion layer FD are extracted to the power supply line of the power supply VDD and the capacitor MEM and the floating diffusion layer FD are reset.

The drive signal scanning unit 120 causes the global shutter trigger to transition from the high state to the low state at time t₈ immediately after the time t₇. The vertical drive unit 112 sets the drive signals TRG2 and RST to the low state and sets the transfer transistor TR2 and the reset transistor TR3 to the OFF state according to the state transition of the global shutter trigger.

The drive signal scanning unit 120 causes the global transfer trigger to transition from the low state to the high state at the time t₈. The vertical drive unit 112 causes the drive signal TRG1 to transition to the high state according to the state transition of the global transfer trigger and sets the transfer transistor TR1 to the ON state. Accordingly, the electric charges accumulated in the photodiode PD in the exposure period are transferred from the photodiode PD to the capacitor MEM. Note that the drive signal scanning unit 120 causes the global transfer trigger to transition from the high state to the low state at time t₉ immediately after the time t₈. The transfer transistor TR1 is set to the OFF state by control of the vertical drive unit 112 involved in the transition.

Here, the transfer of the electric charges accumulated in the photodiode PD to the capacitor MEM at the time t₈ is executed in the pixels 10 included in the pixel array unit 100 all at once. Therefore, as at the time t₂ explained above, the potential of the output voltage Vₒᵤₜ of the charge pump 122 suddenly changes. By increasing the frequency of the clock signal PPCLK for operating the charge pump 122, the pumping operation in the charge pump 122 is executed at high speed and the capacitor C_{fly} is rapidly charged.

At time t₁₀ after elapse of a predetermined time from the time t₆, the drive signal scanning unit 120 causes the mode signal MODE(rd) to transition from the low state to the high state and causes the mode signal MODE(gr/ts) to transition from the high state to the low state. Accordingly, the frequency switching signal is switched from the frequency switching signal FSEL #2 to the frequency switching signal FSEL #1 in the frequency switching control unit 202 according to the truth table of Table 1. The clock signal DCLK(M) having a lower frequency than the clock signal DCLK(H) is selected as the clock signal PPCLK. The processing shifts to the read period of the pixel array unit 100.

As explained above, the frequency of the clock signal PPCLK for driving the charge pump 122 is increased in a period until the pixels 10 included in the pixel array unit 100 are driven all at once and the output voltage Vₒᵤₜ of the charge pump 122 stabilizes. The frequency of the clock signal PPCLK is lowered in a period in which there is no access to the transistors included in the pixels 10 in the pixel array unit 100 or there is little access. Accordingly, it is possible to suppress power consumption when driving the charge pump 122.

By increasing the frequency of the clock signal PPCLK in a period until the pixels 10 included in the pixel array unit 100 are driven all at once and the output voltage Vₒᵤₜ of the charge pump 122 stabilizes, it is possible to reduce the time required for stabilizing the output voltage Vₒᵤₜ of the charge pump 122. Accordingly, the frame rate can be increased.

In the example illustrated in FIG. 6, not only the frequency of the clock signal PPCLK but also the amplitude of the voltage CB is controlled in a period (time t₁ to t₄, time t₆ to t₁₀) in which the clock signal DCLK(H) having the high frequency is used as the clock signal PPCLK. More specifically, the amplitude is increased at the start portions of the periods and the amplitude is reduced toward the ends of the periods (an arrow B in FIG. 6).

For example, the drive signal scanning unit 120 can increase and reduce a feedback voltage in a feedback loop by controlling the reference voltage Vref₀ generated by the reference voltage generation unit 203, thereby controlling the amplitude of the voltage CB. In the example illustrated in FIG. 6, the amplitude of the voltage CB is increased according to the feedback voltage at the start portion of the period in which the clock signal DCLK(H) having the high frequency is used as the clock signal PPCLK (an arrow A in FIG. 6) and, thereafter, the amplitude of the voltage VCP is reduced toward the end of the period (the arrow B in FIG. 6).

As explained above, by controlling not only the frequency of the clock signal PPCLK but also the amplitude of the voltage CB, the time required for stabilizing the output voltage Vout of the charge pump 122 can be further reduced.

Note that, in the example illustrated in FIG. 6, the drive signal scanning unit 120 causes the mode signal MODE(gs) to transition from the low state to the high state at the time t₁ immediately before the shutter instruction is issued at the time t₂. As explained above, before the shutter instruction is actually issued, by outputting a signal indicating a period when the shutter instruction is actually output, the frequency of the clock signal PPCLK can be increased before the fluctuation of the output voltage Vₒᵤₜ of the charge pump 122 increases, which is preferable.

Note that, in the above explanation, the frequency of the clock signal PPCLK for driving the charge pump 122 is switched among the three types of the low frequency, the medium frequency, and the high frequency. An intention for the above is explained below.

In the blank period, the frequency of the clock signal PPCLK is switched to the low frequency. In the blank period, since access to the transistors in the pixel 10 is not performed, it seems as if a voltage value of the negative power supply does not change even if the voltage is not supplied from the charge pump 122. However, the voltage value of the negative power supply increases with a leakage current of the vertical drive unit 112 and a consumed current in natural discharge of the capacitor 123 connected to the output of the charge pump 122. It is necessary to suppress the increase. However, since the increase is very small, a driving capability is not so necessary as in the other operation modes.

Therefore, in the first embodiment, by setting the frequency of the clock signal PPCLK to a frequency lower than the frequency in the read period and performing pumping, the power consumption is reduced while suppressing the voltage increase.

In the read period, the frequency of the clock signal PPCLK is switched to the medium frequency. In the read period, a unit of reading pixel signals at a time is one row to several rows. Reading several rows at a time is sometimes adopted to increase reading speed in the read period. On the other hand, in the read period, reading is sequentially performed for all the rows included in the pixel array unit 100. It is necessary to suppress an increase in the consumption current with pumping of the charge pump 122 so that the voltage value of the negative power supply does not change within the read period of one row to several rows. Note that, actually, if there is no fluctuation in the voltage value of the negative power supply between the P-phase period and the D-phase period, the AD conversion result by the AD converter is not affected. One read period depends on the number of bits of the AD conversion, an AD conversion scheme, and the like. However, in the case of the AD conversion by the single slope scheme explained above, one read period is approximately several psec.

Therefore, considering a relation between the consumed current and the pumping capability, in the read period, a more driving capability is necessary compared to the blank period. However, it is unnecessary to perform pumping at the high frequency.

In the global reset and transfer period and the global shutter period, the frequency of the clock signal PPCLK is switched to the high frequency. In the global reset and transfer period, the reset operation and the transfer operation are executed in all the rows included in the pixel array unit 100 all at once. In the global shutter period, similarly, the shutter operation is executed in all the rows included in the pixel array unit 100 all at once. Therefore, in these periods, an instantaneous consumed current is large and the voltage value of the negative power supply greatly fluctuates. If the voltage of the negative power supply is not restored to the voltage value immediately before the global operation such as the global reset and transfer and the global shutter, the operation cannot be shifted to the next operation. A return time for restoring to the voltage value immediately before the global operation is included in a time in one frame. Therefore, by restoring the negative power supply at a higher speed, the time of one frame can be reduced and the frame rate can be increased.

Therefore, in the first embodiment, in the global reset and transfer period and the global shutter period, the pumping in the charge pump 122 is executed by the clock signal PPCLK having a frequency higher than the frequency in the read period to restore the negative power supply in a shorter time.

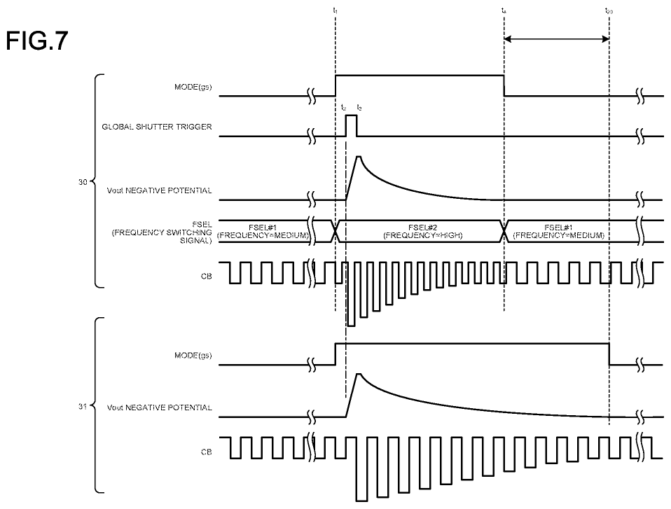

FIG. 7 is a diagram for comparing control of the charge pump 122 according to the first embodiment and control by the existing technique. In FIG. 7, a chart 30 is a diagram obtained by extracting the mode signal MODE(gs), the global shutter trigger, the output voltage Vₒᵤₜ of the charge pump 122, the frequency switching signal FSEL, and the voltage CB in FIG. 6 explained above from the start to the middle of the times t₄ and t₅ in FIG. 6.

On the other hand, a chart 31 illustrates an example in a case where the frequency of the clock signal PPCLK for driving the charge pump 122 is fixed according to the existing technique. This corresponds to, for example, the technique disclosed in Patent Literature 1. Note that a configuration applied to the chart 31 is similar to the configuration illustrated in FIG. 4 and FIG. 5.

In the chart 31, as in the chart 30, it is assumed that the mode signal MODE(gs) is caused to transition from the low state to the high state at the time t₁. Further, it is assumed that the transition of the drive signal OFG from the low state to the high state is executed in the pixels 10 included in the pixel array unit 100 all at once at timing corresponding to the time t₂. The potential of the output voltage Vₒᵤₜ of the charge pump 122 rapidly changes according to the transition of the state of the drive signal OFG.

Here, it is assumed that displacement of the potential of the output voltage Vₒᵤₜ of the charge pump 122 is recovered by a constant number of times of the pumping operation. In this case, in the example of the chart 31, since the frequency of the clock signal PPCLK for driving the charge pump 122 is constant, it takes a longer time until the output voltage Vₒᵤₜ stabilizes compared with an example of the chart 30 in which the frequency is set higher. In the example illustrated in FIG. 7, in the method according to the existing technique, the output voltage Vₒᵤₜ stabilizes at time t₂₀, which is temporally later than the time t₄ explained above. That is, by performing the drive control for the charge pump 122 according to the first embodiment, the state of the capacitor C_{fly} can be restored at high speed by the difference between the time t₂₀ and the time t₄.

Note that, in the first embodiment, a power saving function and the like are realized by controlling the frequency of the clock signal PPCLK. Here, by controlling the clock signal PPCLK to divide the clock signal CPCLK according to a band of a cutoff filter in the CDS processing, it is possible to suppress noise that is likely to be generated from the charge pump 122 and affect a pixel signal.

In the first embodiment, the feedback voltage of the feedback loop for controlling the amplitude of the voltage VCP is changed by controlling the reference voltage Vref₀ generated by the reference voltage generation unit 203. Therefore, it is unnecessary to consider a time required for stable restoration of the voltage of the feedback loop relating to the amplitude control of the voltage VCP and output fluctuation at the time of restoration compared with a method of once disconnecting the feedback loop to switch the feedback loop to the boost voltage in Patent Literature 1.

For example, the drive signal scanning unit 120 can increase and reduce a feedback voltage in a feedback loop by controlling the reference voltage Vref₀ generated by the reference voltage generation unit 203, thereby controlling the amplitude of the voltage CB. In the example illustrated in FIG. 6, the amplitude of the voltage CB is increased according to the feedback voltage at the start portion of the period in which the clock signal DCLK(H) having the high frequency is used as the clock signal PPCLK (the arrow A in FIG. 6) and, thereafter, the amplitude of the voltage CB is reduced toward the end of the period (the arrow B in FIG. 6).

As explained above, by controlling not only the frequency of the clock signal PPCLK but also the amplitude of the voltage CB, the time required for stabilizing the output voltage Vout of the charge pump 122 can be further reduced.

### 2-0-1. More Detailed Description of the Effects of the First Embodiment

Here, the effects of the first embodiment are explained in more detail. As explained above, the pixel 10 applied to the first embodiment is configured by the CMOS circuit. However, power consumption of the CMOS circuit is mainly power consumption due to charging and discharging currents and a through-current. Note that it is assumed that power consumption due to a leakage current is smaller than these two consumed currents. When a frequency of a switching signal is represented as f_{c} [Hz], a load capacity is represented as C_{L} [F], a power supply voltage is represented as V_{DD} [V], and a through-current flowing from a power supply to the ground is represented as i_{dp}(t) [A], power consumption Pow_{cg} by the charging and discharging currents and power consumption Pow_{tc} by the through-current are represented by the following expressions (1) and (2).

Pow_{cg}=f_{c}C_{L}V²_{DD} (1)

Pow_{tc}=f_{c}V_{DD}∫₀^{1/f}^{_{c}}i_{dp}(t)dt (2)

In a normal time, the voltage V_{DD} (signal amplitude of the switching signal) is a voltage conforming to the feedback voltage. This is the same as, for example, the existing technique described in Patent Literature 1. Therefore, in the first embodiment in which the frequency f_{c} can be varied and reduced, the power consumption can be reduced.

An electric current that can be output by the charge pump 122 in a certain period t [sec] is represented by the following expression (3) when a pumping capacity value (a capacity value of the capacitor C_{fly}) is represented as C_{fly} [Hz], a power supply voltage by the power supply VDD is represented as V_{DD} [V], a negative potential output of the charge pump 122 is represented as VCP [V], and a frequency of the switching signal (the clock signal PPCLK) is represented as f_{c} [Hz].

$${l}_{cp} = {C}_{fly} \times ( {V}_{DD} - {V}_{CP} ) \times {f}_{c} \times \frac{1}{t} \qquad ( 3 )$$

It is seen according Expression (3) that a large current can be obtained within a certain period by increasing the frequency f_{c}.

As a method of switching a pumping frequency for driving a pumping operation, a method of using a voltage-controlled oscillator (VCO) at a feedback voltage is known (for example, Patent Literature 2). In the method using the VCO, the pumping frequency can be switched in an analog infinite stage. The power consumption and the driving capability can be controlled more finely and the system can be closed on the analog side.

On the other hand, in the method using the VCO for the switching of the pumping frequency, the frequency range to be controlled can be limited to some extent. However, since the frequency changes at any time, it is difficult for the system side to grasp which frequency is to be used. Therefore, the imaging element to which the method is applied is likely to cause noise in a frequency band used by radio or an interface (I/F) mounted in the system.

Since the imaging element 4 according to the first embodiment generates the clock signal PPCLK for driving the charge pump 122 by digitally dividing the clock signal PPCLK to predetermined frequencies with the frequency divider 200, these frequencies can be avoided. When a block affected by the clock signal PPCLK is operating in the system, the charge pump 122 included in the imaging element 4 according to the first embodiment can reduce the power or increase the driving capability as necessary while avoiding the block by changing the frequency band.

Further, the frequency used in the CIS can be divided and synchronized with the pumping frequency and the frequency used in the column processing unit 114. Accordingly, pumping can be performed at a frequency that can be removed by the filter used in the CDS processing. Noise to the column processing unit 114 by the charge pump 122 at the time of reading can be suppressed.

When the driving capability is increased by increasing the voltage amplitude of pumping, the switching noise also increases. When the driving capability of the charge pump 122 is increased by increasing the pumping frequency, this switching noise can be removed by the CDS filter if the pumping frequency is a multiple of the cutoff frequency of the CDS filter. Therefore, as the control of the driving capability by the charge pump 122, the frequency control is more advantageous than in the voltage control.

Note that, even when the voltage amplitude relating to the pumping is large, the switching noise can be removed by the CDS filter in the same manner if the pumping frequency is a multiple of the cutoff frequency of the CDS filter. However, since the noise cannot be completely removed by this method, the absolute amount of the noise is preferably small.

In the fast trigger mode in which the shutter is driven at an any timing among the operation modes of the shutter, the shutter is driven during the read period and the negative potential stabilization waiting period is not provided. Therefore, when noise occurs from the charge pump 122, there is a possibility that the AD conversion processing in the column processing unit 114 is affected. Therefore, for the reasons explained above, it is desirable to control the driving capability of the charge pump 122 by frequency control.

In the example explained above, the driving capability of the charge pump 122 is changed by changing the voltage amplitude with the feedback voltage in addition to the frequency control. However, the driving capability may be changed only by the frequency control not by the voltage amplitude according to necessity.

### 2-1. First Modification of the First Embodiment

Next, a first modification of the first embodiment is explained. In the first embodiment explained above, the frequency of the clock signal PPCLK for driving the charge pump 122 is selected on an output side of the selector 201. In contrast, the first modification of the first embodiment is an example in which the frequency of the clock signal PPCLK is selected on an input side of the selector 201.

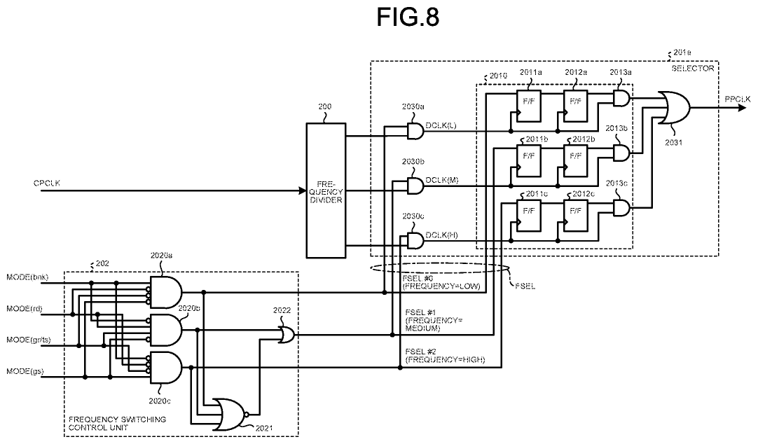

FIG. 8 is a block diagram illustrating a configuration of an example for selecting a frequency of a clock signal for driving a charge pump according to the first modification of the first embodiment. In FIG. 8, in a selector 201a, AND circuits 2030a, 2030b, and 2030c are added to an input side of the synchronization circuit 2010 of the selector 201 illustrated in FIG. 5. At the same time, instead of the switch circuits 2014a, 2014b, and 2014c on an output side of the synchronization circuit 2010, a three-input OR circuit 2031 is provided.

The frequency switching signal FSEL #0 output from the frequency switching control unit 202 is input to a first input end of the AND circuit 2030a. The clock signal DCLK(L) generated by dividing the clock signal CPCLK in the frequency divider 200 is input to a second input end of the AND circuit 2030a. An output of the AND circuit 2030a is input to the clock input ends of the flip-flop circuits 2011a and 2012a of the synchronization circuit 2010 and is input to a second input end of the AND circuit 2013a. The frequency switching signal FSEL #0 output from the frequency switching control unit 202 is input to the data input ends of the flip-flop circuits 2011a and 2012a. An output of the AND circuit 2013a is input to a first input end of the OR circuit 2031.

Thereafter, similarly, the frequency switching signal FSEL #1 is input to a first input end of the AND circuit 2030b, and the clock signal DCLK(M) is input to a second input end of the AND circuit 2030b. An output of the AND circuit 2030b is input to clock input ends of the flip-flop circuits 2011b and 2012b and is input to a second input end of the AND circuit 2013b. The frequency switching signal FSEL #1 is input to data input ends of the flip-flop circuits 2011b and 2012b. An output of the AND circuit 2013b is input to a second input end of the OR circuit 2031.

The frequency switching signal FSEL #2 is input to a first input end of the AND circuit 2030c and the clock signal DCLK(H) is input to a second input end of the AND circuit 2030c. An output of the AND circuit 2030c is input to the clock input ends of the flip-flop circuits 2011b and 2012b and is input to a second input end of the AND circuit 2013c. The frequency switching signal FSEL #2 is input to the data input ends of the flip-flop circuits 2011b and 2012b. An output of the AND circuit 2013c is input to a third input end of the OR circuit 2031.

An output of the OR circuit 2031 is output from the selector 201a as the clock signal PPCLK.

In such a configuration, as the clock signals DCLK(L), DCLK(M), and DCLK(H), the clock signal DCLK corresponding to the frequency switching signal FSEL in the high state among the frequency switching signals FSEL #0, FSEL #1, and FSEL #2 is selected by the AND circuits 2030a, 2030b, and 2030c. On the other hand, the clock signal DCLK corresponding to the frequency switching signal FSEL in the low state among the frequency switching signals FSEL #0, FSEL #1, and FSEL #2 is not selected.

For example, when the clock signal DCLK(L) is selected among the clock signals DCLK(L), DCLK(M), and DCLK(H), the flip-flop circuits 2011a and 2012a to which the clock signal DCLK(L) is input operate according to the input clock signal DCLK(L). On the other hand, since the clock signals DCLK(M) and DCLK(H) are not respectively input to the flip-flop circuits 2011b and 2012b and the flip-flop circuits 2011c and 2012c, the operations thereof are stopped. Therefore, power consumption by the flip-flop circuits 2011b and 2012b and the flip-flop circuits 2011c and 2012c can be suppressed.

As explained above, by selecting the frequency of the clock signal PPCLK on the input side of the selector 201, the charge pump 122 can be appropriately controlled according to the operation of the pixel array unit 100 and the power consumption can be suppressed.

### 2-2. Second Modification of the First Embodiment

Subsequently, a second modification of the first embodiment is explained. The second modification of the first embodiment is an example in which a plurality of clock signals DCLK to be selected as the frequency of the clock signal PPCLK is generated by individual frequency dividers and it is controlled which one of the frequency dividers is enabled.

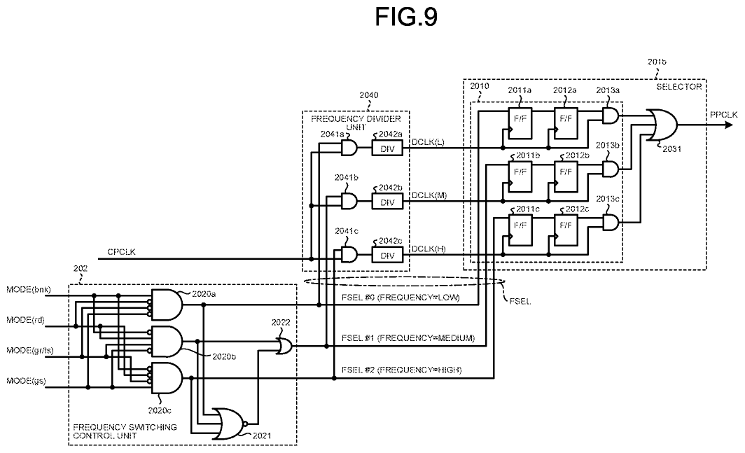

FIG. 9 is a block diagram illustrating a configuration of an example for selecting a frequency of a clock signal for driving a charge pump according to the second modification of the first embodiment. In FIG. 9, a configuration of a range indicated by a dotted frame of a selector 201b is common to a configuration in which the AND circuits 2030a to 2030c are removed from the selector 201a illustrated in FIG. 8 explained above. Therefore, explanation of the configuration is omitted.

In FIG. 9, a frequency divider unit 2040 includes a plurality of frequency dividers DIV 2042a, 204b, and 2042c and a plurality of AND circuits 2041a, 2041b, and 2041c respectively corresponding to the clock signals DCLK(L), DCLK(M), and DCLK(H). The selector 201b has a configuration in which the AND circuits 2041a, 2041b, and 2041c are included in the configuration in the range indicated by the dotted frame in FIG. 9.

The frequency switching signal FSEL #0 is input to a first input end of the AND circuit 2041a, the frequency switching signal FSEL #1 is input to a first input end of the AND circuit 2041b, and the frequency switching signal FSEL #2 is input to a first input end of the AND circuit 2041c. The clock signal CPCLK is input to second input ends of the AND circuits 2041a, 2041b, and 2041c in commonly.

An output of the AND circuit 2041a is input to the frequency divider DIV 2042a and an output of the frequency divider DIV 2042a is input to the clock input ends of the flip-flop circuits 2011a and 2012a included in the synchronization circuit 2010 and is input to the second input end of the AND circuit 2013a. Similarly, an output of the AND circuit 2041b is input to the frequency divider DIV 2042b and an output of the frequency divider DIV 2042 is input to the clock input ends of the flip-flop circuits 2011b and 2012b and is input to the second input end of the AND circuit 2013b. An output of the AND circuit 2041c is input to the frequency divider DIV 2042c and an output of the frequency divider DIV 2042c is input to the clock input ends of the flip-flop circuits 2011c and 2012c and is input to the second input end of the AND circuit 2013c.

In such a configuration, for example, the AND circuit 2041a outputs the clock signal CPCLK to the frequency divider DIV 2042a when the frequency switching signal FSEL #0 is in the high state. The frequency divider DIV 2042a divides the clock signal CPCLK supplied from the AND circuit 2041a to generate the clock signal DCLK(L). As explained above, the clock signal DCLK(L) is input to the clock input ends of the flip-flop circuits 2011a and 2012a and is input to the second input end of the AND circuit 2013a.

On the other hand, since the AND circuit 2041a does not output the clock signal CPCLK when the frequency switching signal FSEL #0 is in the low state, the frequency divider DIV 2042a does not perform the frequency dividing operation. Accordingly, the flip-flop circuits 2011a and 2012a do not operate either since the clock signal DCLK(L) is not input to the clock input end.

The above operation is similar in the AND circuit 2041b and the frequency divider DIV 2042b and in the AND circuit 2041c and the frequency divider DIV 2042c.

As explained above, in the second modification of the first embodiment, the clock signals DCLK(L), DCLK(M), and DCLK(H) of the respective frequencies are generated by the individual frequency dividers DIV 2042a, 2042b, and 2042c and the operations of the frequency dividers DIV 2042a, 2042b, and 2042c are controlled by the frequency switching signals FSEL #0, FSEL #1, and FSEL #2. Accordingly, in the second modification of the first embodiment, in addition to the first modification of the first embodiment explained above, the operation of a frequency divider corresponding to a clock frequency that is not selected among the frequency dividers DIV 2042a to 2042c can be further stopped. Lower power consumption can be realized.

### 2-3. Third Modification of the First Embodiment

Subsequently, a third modification of the first embodiment is explained. In the first embodiment explained above, the imaging is explained as being performed by the global shutter scheme in the pixel array unit 100. However, this is not limited to this example. The third modification of the first embodiment is an example in which the present disclosure is applied to a case where imaging is performed by a rolling shutter scheme.

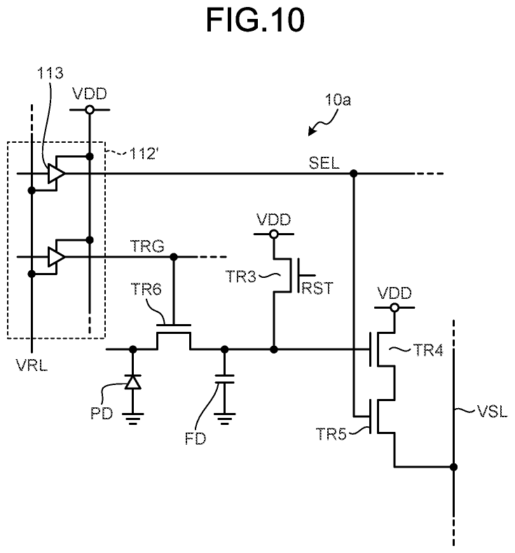

FIG. 10 is a circuit diagram illustrating a configuration of an example of a pixel applicable to the third modification of the first embodiment. A pixel 10a illustrated in FIG. 10 has a configuration in which the OFG transistor TR0, the transfer transistor TR1 or TR2, and the capacitor MEM are omitted from the configuration of the pixel 10 illustrated in FIG. 3 explained above. A transfer transistor TR6 illustrated in FIG. 10 corresponds to the transfer transistor TR1 or TR2 illustrated in FIG. 3 explained above and controls transfer of electric charges accumulated in the photodiode PD to the floating diffusion layer FD according to the drive signal TRG supplied from a vertical drive unit 112′. The vertical drive unit 112′ includes two amplifiers 113 for one pixel 10a.

In the pixel 10a, the vertical scanning unit 110 sets the transfer transistor TR6 to the OFF state with the drive signal TRG according to a control signal from the drive signal scanning unit 120 during exposure and causes the photodiode PD to accumulate electric charges generated according to light made incident by photoelectric conversion. After the exposure ends, the vertical scanning unit 110 sets the path selection transistor TR5 to the ON state with the drive signal SEL according to a control signal from the drive signal scanning unit 120 and connects the floating diffusion layer FD and the vertical signal line VSL.

The vertical scanning unit 110 sets the reset transistor TR3 to the ON state with the drive signal RST, connects the floating diffusion layer FD to the power supply line of the power supply VDD or a supply line of a black level voltage in a short period, and resets the floating diffusion layer FD. The voltage of the reset level of the floating diffusion layer FD by the P-phase reading is output to the vertical signal line VSL. Thereafter, the vertical scanning unit 110 sets the transfer transistor TR6 to the ON state with the drive signal TRG according to a control signal from the drive signal scanning unit 120, transfers the electric charges accumulated in the photodiode PD to the floating diffusion layer FD, and performs the D-phase reading. By this D-phase reading, a voltage corresponding to a charge amount of the floating diffusion layer FD is output to the vertical signal line VSL.

The read operation explained above is executed in the pixels 10a arranged in one row all at once. Further, the read operation of the rows is executed row by row. Accordingly, imaging by the rolling shutter scheme is realized.

Note that the processing explained with reference to FIG. 3 can be applied to processing such as AD conversion processing and CDS processing by the column processing unit 114 in the configuration illustrated in FIG. 10. Therefore, explanation of the processing is omitted.

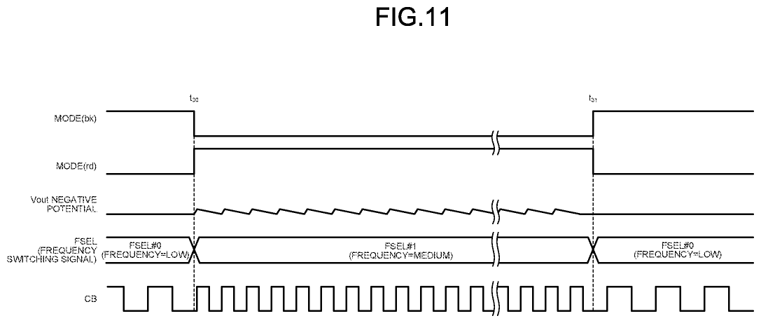

FIG. 11 is a sequence chart illustrating an example of a control operation of a charge pump according to the third modification of the first embodiment. In the third modification of the first embodiment, only the mode signal MODE(br) functioning as a flag signal of the blank period and the mode signal MODE(rd) functioning as a flag signal of the read period are used as the mode signal MODE. In FIG. 11, elapse of time is illustrated in the right direction and the vertical direction illustrates, from the top, signals and timings of the mode signals MODE(br) and MODE(rd), the output voltage Vₒᵤₜ due to the negative potential of the charge pump 122, the frequency switching signal FSEL, and the voltage VCP corresponding to the output voltage Vₒᵤₜ of the charge pump 122.

Note that, in FIG. 11, among control operations in the pixel array unit 100, control operations relating to the entire pixel array unit 100 are extracted and illustrated. For example, operations executed for each row of the pixel array unit 100 are omitted.

In FIG. 11, the drive signal scanning unit 120 causes the mode signal MODE(br) to transition from the high state to the low state and causes the mode signal MODE(rd) to transition from the low state to the high state at time t₃₀ and sets the operation mode to an operation mode period (a shutter and read period) of shutter and read. In the shutter and read period, the frequency switching control unit 202 outputs the frequency switching signal FSEL #1 according to the mode signals MODE(bk) and MODE (rd). In the selector 201, the clock signal DCLK(M) having the medium frequency is selected as the clock signal PPCLK for driving the charge pump 122 according to the frequency switching signal FSEL #1.

The drive signal scanning unit 120 causes the mode signal MODE(br) to transition from the low state to the high state and causes the mode signal MODE(rd) to transition from the high state to the high state at time t₃₁ after a predetermined time (for example, after the lapse of a time corresponding to a frame rate) from the time t₃₀ and sets the operation mode to a blank operation mode period (a blank period). In the blank period, the frequency switching control unit 202 outputs the frequency switching signal FSEL #0 according to the mode signals MODE(bk) and MODE (rd). In the selector 201, the clock signal DCLK(L) having the low frequency is selected as the clock signal PPCLK for driving the charge pump 122 according to the frequency switching signal FSEL #0.

In the pixel array unit 100, in the shutter and read period, the shutter operation and the read operation are sequentially executed for each one row or plurality of rows. Accordingly, in the pixel array unit 100, the read operation is sequentially performed for each one row or plurality of rows and the output voltage Vₒᵤₜ of the charge pump 122 repeats fluctuation for each row. In the case of the rolling shutter scheme, since the reading is sequentially performed for each row or several rows, the fluctuation of the output voltage Vout of the charge pump 122 is small compared with the global shutter scheme explained with reference to FIG. 6. In the shutter and read period, the frequency of the clock signal PPCLK for driving the charge pump 122 is set to, for example, the medium frequency and the charge pump 122 is driven with a normal driving capability.

On the other hand, in the blank period, the frequency of the clock signal PPCLK is switched to, for example, the low frequency to reduce the driving capability by the charge pump 122. Accordingly, even in the rolling shutter scheme, it is possible to reduce the power consumption of the charge pump 122.

### 2-4. Fourth Modification of the First Embodiment

Subsequently, a fourth modification of the first embodiment is explained. The fourth modification of the first embodiment is an example in which a mechanical shutter scheme for controlling an exposure time in the photodiode PD with a shutter mechanism is applied to the shutter scheme. In the fourth modification of the first embodiment, since the configuration of the pixel 10a according to the third modification of the first embodiment explained with reference to FIG. 10 can be directly applied to the configuration of a pixel, explanation of the configuration of the pixel is omitted.

In the case of the mechanical shutter scheme, the vertical scanning unit 110 causes the transfer transistors TR6 and TR3 illustrated in FIG. 10 to simultaneously transition from the OFF state to the ON state in the pixel array unit 100 according to a control signal from the drive signal scanning unit 120 and resets the photodiodes PD of all the pixels 10a all at once. Thereafter, the vertical scanning unit 110 causes the transfer transistors TR6 and TR3 to simultaneously transition from the ON state to the OFF state. For example, the mechanical shutter is set to an open state by the control unit 3. When the mechanical shutter is set to the open state, the vertical scanning unit 110 reads a pixel signal with a rolling operation for each one row or several rows according to a control signal from the drive signal scanning unit 120.

In the case of the mechanical shutter scheme, as explained above, since the pixels 10a included in the pixel array unit 100 are simultaneously driven, the load of the negative power supply instantaneously increases. Therefore, the frequency of the clock signal PPCLK is switched from the low frequency or the medium frequency to the high frequency for a predetermined period after the transfer transistors TR6 and TR3 are caused to simultaneously transition from the OFF state to the ON state in the pixel array unit 100 and the driving capability of the charge pump 122 is increased. Accordingly, the time until the negative potential of the negative power supply is restored after the reset operation of the photodiode PD can be reduced and the frame rate can be increased.

Note that, in the mechanical shutter scheme, in the read period and the blank period, the frequency of the clock signal PPCLK is set to the medium frequency and the low frequency, respectively, as in the global shutter scheme explained with reference to FIG. 6.

### 2-5. Fifth Modification of the First Embodiment

Subsequently, a fifth modification of the first embodiment is explained. The fifth modification of the first embodiment is an example in which an FD holding scheme for performing global shutter scheme imaging in the pixel configuration illustrated in FIG. 10, that is, a pixel configuration not using an OFG transistor is applied as the shutter scheme. In the fifth modification of the first embodiment, since the configuration of the pixel 10a according to the third modification of the first embodiment explained with reference to FIG. 10 can be directly applied, explanation of the configuration of the pixel is omitted.

In the FD holding scheme, the vertical scanning unit 110 causes the transfer transistors TR6 and TR3 to simultaneously transition from the OFF state to the ON state in the pixel array unit 100 according to a control signal from the drive signal scanning unit 120 and resets the photodiodes PD of all the pixels 10a all at once. Thereafter, the vertical scanning unit 110 causes the transfer transistors TR6 and TR3 to simultaneously transition from the ON state to the OFF state and starts exposure for the photodiode PD.

Thereafter, according to a control signal from the drive signal scanning unit 120, the vertical scanning unit 110 causes the transfer transistor TR6 to simultaneously transition from the OFF state to the ON state in the pixel array unit 100 and transfers the electric charges accumulated in the photodiode PD by exposure to the floating diffusion layer FD. When the transfer of the electric charges to the floating diffusion layer FD ends, the vertical scanning unit 110 causes the transfer transistor TR6 to transition to the OFF state according to a control signal from the drive signal scanning unit 120. Thereafter, a pixel signal is read by the rolling operation for each one row or several rows.

In this FD holding scheme as well, since the pixels 10a included in the pixel array unit 100 are simultaneously driven at the reset time of the photodiode PD and the transfer time of the electric charges accumulated in the photodiode PD to the floating diffusion layer FD, the load of the negative power supply instantaneously increases. Therefore, for example, at the reset time of the photodiode PD, the frequency of the clock signal PPCLK is switched from the low frequency or the medium frequency to the high frequency for a predetermined period after the transfer transistors TR6 and TR3 are caused to simultaneously transition from the OFF state to the ON state in the pixel array unit 100 and the driving capability of the charge pump 122 is increased. Accordingly, the time until the negative potential of the negative power supply is restored after the reset operation of the photodiode PD can be reduced and the frame rate can be increased. The same applies when the electric charges accumulated in the photodiode PD are transferred to the floating diffusion layer FD.

Note that, in the FD holding scheme as well, the frequency of the clock signal PPCLK is set to the medium frequency and the low frequency respectively in the read period and the blank period as in the global shutter scheme explained with reference to FIG. 6.

### 2-6. Sixth Modification of the First Embodiment

Subsequently, a sixth modification of the first embodiment is explained. The sixth modification of the first embodiment is an example in which a pixel analog to digital converter (ADC) configuration including an AD converter for each pixel is applied as a pixel configuration.

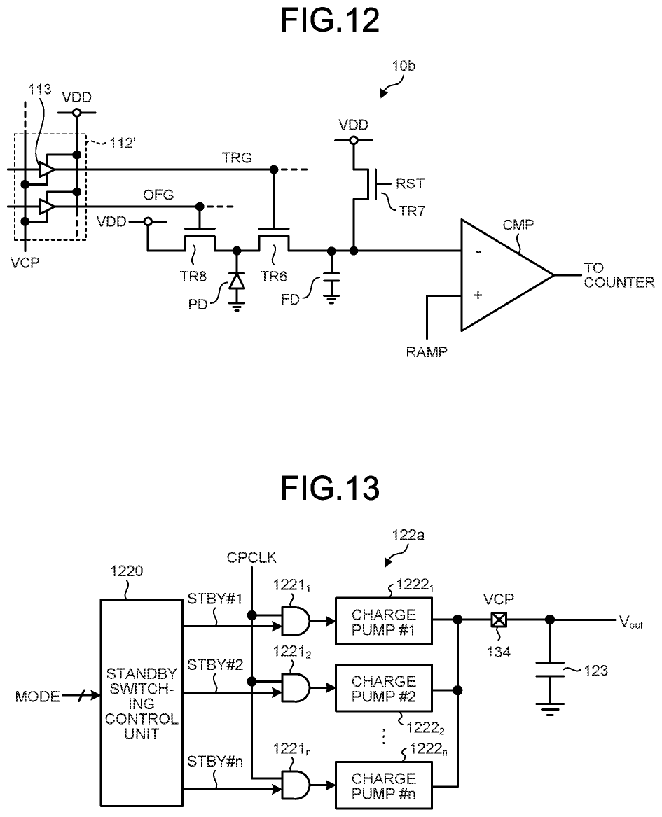

FIG. 12 is a circuit diagram illustrating a configuration of an example of a pixel applicable to the sixth modification of the first embodiment. In a pixel 10b illustrated in FIG. 12, an OFG transistor TR8 driven by the drive signal OFG is added to the cathode of the photodiode PD in the rolling shutter scheme pixel 10a illustrated in FIG. 10 explained above. A drain of the OFG transistor TR8 is connected to the power supply line of the power supply VDD and a source of the OFG transistor TR8 is connected to the cathode of the photodiode PD and the drain of the transfer transistor TR6. A gate of the OFG transistor TR8 is connected to the vertical drive unit 112.

The floating diffusion layer FD is connected to the sources of the transfer transistor TR6 and a reset transistor TR7 and is connected to a (−) side input end of a comparator CMP. The RAMP signal, the voltage of which based on the straight line increases or decreases stepwise, is input to a (+) side input end of the comparator CMP. An output of the comparator CMP is connected to a counter that counts a time from a predetermined position (for example, a start point) of a slope of the RAMP signal until when the RAMP signal and a voltage due to the electric charges accumulated in the floating diffusion layer FD coincide and calculates a digital value of a voltage value due to the electric charges.

Further, a drain of the reset transistor TR7 that controls the reset operation is connected to the power supply line of the power supply VDD. When the reset transistor TR7 is set to the ON state according to the drive signal RST, the floating diffusion layer FD is initialized by a positive potential power supply voltage of the comparator CMP.

In the configuration illustrated in FIG. 12, a shutter operation by the global shutter scheme is performed. That is, according to a control signal from the drive signal scanning unit 120, the vertical scanning unit 110 causes the OFG transistor TR8 to transition from the OFF state to the ON state all at once in the pixels 10b of the pixel array unit 100 in the OFF state of the transfer transistor TR6 and initializes the photodiodes PD of the pixels 10b. Thereafter, the vertical drive unit 112 causes the OFG transistor TR8 to transition from the ON state to the OFF state while maintaining the OFF state of the transfer transistor TR6 according to a control signal from the drive signal scanning unit 120. Accordingly, exposure can be started in the photodiode PD.

When the exposure is completed, the vertical drive unit 112 causes the transfer transistor TR6 to transition from the OFF state to the ON state in the pixels 10b of the pixel array unit 100 all at once while maintaining the OFF state of the OFG transistor TR8 according to a control signal from the drive signal scanning unit 120. Accordingly, a voltage corresponding to the electric charges accumulated in the floating diffusion layer FD is input to the (−) side input end of the comparator CMP (a read operation) and the AD conversion processing is performed.

In this pixel ADC scheme as well, at a reset time of the photodiode PD and at a transfer time of the electric charges accumulated in the photodiode PD to the floating diffusion layer FD, the pixels 10b included in the pixel array unit 100 are simultaneously driven. Therefore, the load of the negative power supply instantaneously increases. Therefore, for example, at the reset time of the photodiode PD, the frequency of the clock signal PPCLK is switched from the low frequency or the medium frequency to the high frequency for a predetermined period after the OFG transistor TR8 is simultaneously caused to transition from the OFF state to the ON state in the pixel array unit 100 and the driving capability by the charge pump 122 is increased. Accordingly, the time until the negative potential of the negative power supply is restored after the reset operation of the photodiode PD can be reduced and the frame rate can be increased. The same applies when the electric charges accumulated in the photodiode PD are transferred to the floating diffusion layer FD.

Note that, in the pixel ADC scheme as well, the frequency of the clock signal PPCLK is set to the medium frequency and the low frequency respectively in the read period and the blank period as in the global shutter scheme explained with reference to FIG. 6.

### 2-7. Seventh Modification of the First Embodiment

Subsequently, a seventh modification of the first embodiment is explained. The seventh modification of the first embodiment is an example in a case where the imaging region is limited to a region of interest (ROI) for all the pixels of the pixel array unit 100 in the global shutter scheme. This imaging scheme is referred to as a ROI scheme for convenience. In this case, the configuration illustrated in FIG. 3 can be directly applied as the pixel configuration. For example, the pixel array unit 100 is configured to be capable of supplying drive signals by the vertical drive unit 112 to the pixels 10 arranged in one row by specifying a range in the row.

When a range in which a pixel signal is read (a read operation) is limited by the ROI scheme, the load of the negative power supply also varies depending on a limited region. Therefore, the frequency of the clock signal PPCLK is adaptively switched according to a region and the driving capability of the charge pump 122 is changed. For example, when the range of the read operation is narrow, since the load of the negative power supply is small, the frequency of the clock signal PPCLK can be set to the medium or low frequency and a reduction in the power consumption can be achieved.

### 3. Second Embodiment

Subsequently, a second embodiment of the present disclosure is explained. In the second embodiment of the present disclosure, a plurality of charge pumps is provided and a driving capability for driving the vertical drive unit 112 is changed by changing the number of charge pumps to be operated according to an operation mode.

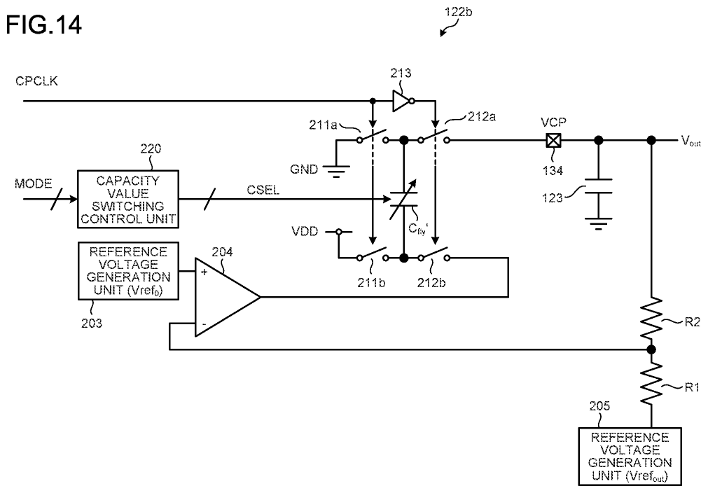

FIG. 13 is a diagram schematically illustrating a configuration of an example of a charge pump according to the second embodiment. In FIG. 13, a charge pump 122a includes a plurality of charge pumps 1222₁, 1222₂, . . . , and 1222ₙ. Note that, in FIG. 13, the charge pumps 1222₁, 1222₂, . . . , and 1222ₙ are respectively illustrated as charge pumps #1, #2, . . . , and #n as well.

For example, a configuration in which the frequency divider 200, the selector 201, and the frequency switching control unit 202 are removed from the charge pump 122 illustrated in FIG. 4 can be applied to each of the charge pumps 1222₁, 1222₂, . . . , and 1222ₙ.

In FIG. 13, a charge pump 122b further includes a standby switching control unit 1220 and a plurality of AND circuits 1221₁, 1221₂, . . . , and 1221ₙ. The clock signal CPCLK having a predetermined frequency for driving the charge pumps 1222₁, 1222₂, . . . , and 1222ₙ is input to first input ends of the AND circuits 1221₁, 1221₂, . . . , and 1221ₙ.

The standby switching control unit 1220 is supplied with the mode signals MODE from the drive signal scanning unit 120. The standby switching control unit 1220 generates standby signals STBY #1, STBY #2, . . . , and STBY #n respectively based on the periods indicated by the input mode signals MODE. The standby signals STBY #1, STBY #2, . . . , and STBY #n are respectively input to second input ends of the AND circuits 1221₁, 1221₂, . . . , and 1221ₙ

The AND circuits 1221₁, 1221₂, . . . , and 1221ₙ supply the clock signal CPCLK input to the first input ends respectively to the corresponding charge pumps 1222₁, 1222₂, . . . , and 1222ₙ when the standby signals STBY #1, STBY #2, . . . , and STBY #n input to the second input ends are, for example, in a high state. When the clock signal CPCLK is input, the charge pumps 1222₁, 1222₂, . . . , and 1222ₙ execute pumping operation and output the output voltage Vout.

In such a configuration, the standby switching control unit 1220 generates the standby signals STBY #1, STBY #2, . . . , and STBY #n according to the input mode signal MODE to control the number of charge pumps to be operated simultaneously among the charge pumps 1222₁, 1222₂, . . . , and 1222ₙ.

Here, for explanation, it is assumed that n=3 and the charge pump 122a includes three charge pumps #1, #2, and #3. The AND circuits 1221₁, 1221₂, . . . corresponding to the three charge pumps #1, #2, and #3 are respectively referred to as an AND circuit #1, an AND circuit #2, and an AND circuit #3, respectively.

It is assumed that the pixel array unit 100 operates in the same manner as the operation illustrated in the sequence chart of FIG. 6 explained above based on a control signal generated by the drive signal scanning unit 120. The standby switching control unit 1220 generates the standby signals STBY #1, STBY #2, and STBY #3 to be respectively input to the second input ends of the AND circuit #1, the AND circuit #2, and the AND circuit #3 based on the mode signals MODE(bk), MODE(rd), MODE(gr/ts), and MODE(gs) explained with reference to FIG. 6.

As a more specific example, the standby switching control unit 1220 sets the standby signal STBY #1 to the high state and sets the standby signals STBY #2 and STBY #3 to the low state in a period (for example, a blank period) of the frequency switching signal #0, which is a period in which a frequency is low in the frequency switching signal FSEL illustrated in FIG. 6. Accordingly, the charge pump #1 changes to an operating state and the charge pumps #2 and #3 change to a standby state (a resting state).

The standby switching control unit 1220 sets the standby signals STBY #1 and STBY #2 to the high state and sets the standby signal STBY #3 to the low state in a period of the frequency switching signal #1 (for example, a read period excluding a global shutter period), which is a period of the medium frequency in the frequency switching signal FSEL illustrated in FIG. 6. Accordingly, the charge pumps #1 and #2 change to the operating state and the charge pump #3 changes to the standby state. Since the two charge pumps are operating, the driving capability of the charge pump 122a as a whole increases compared with the state explained above in which only one charge pump #1 is operating.

Further, the standby switching control unit 1220 sets all of the standby signals STBY #1, STBY #2, and STBY #3 to the high state in a period (a negative potential stabilization waiting period) of the frequency switching signal #2, which is a period of the high frequency in the frequency switching signal FSEL illustrated in FIG. 6. Accordingly, all of the charge pumps #1, #2, and #3 change to the operating state. Since the three charge pumps operate, the driving capability of the charge pump 122a as a whole is further increased compared with the state explained above in which the two charge pumps #1 and #2 are operating.

For example, in a large-sized imaging element 4 including a large number of pixels 10 included in the pixel array unit 100 and a large pixel region, a plurality of charge pumps 1222₁, 1222₂, . . . , and 1222ₙ is sometimes mounted to drive a large number of pixels 10. In the second embodiment, the number of charge pumps to be operated by controlling the standby signals STBY #1, STBY #2, . . . , and STBY #n for the charge pumps 1222₁, 1222₂, . . . , and 1222ₙ is changed by the mode signals MODE supplied from the drive signal scanning unit 120 explained above.

It is possible to suppress the power consumption of the charge pump 122a as a whole according to the number of charge pumps in the standby state among the charge pumps 1222₁, 1222₂, . . . , and 1222ₙ. If the number of charge pumps to be operated is increased, the driving capability of the charge pump 122a as a whole can be increased.

### 4. Third Embodiment

Subsequently, a third embodiment of the present disclosure is explained. In the third embodiment of the present disclosure, a driving capability for driving the vertical drive unit 112 is changed by making a pumping capacitor in a charge pump variable. More specifically, the driving capability of the charge pump can be reduced by reducing a capacity value of the pumping capacitor and the driving capability of the charge pump can be increased by increasing the capacity value.

For example, when a capacity value of the capacitor C_{fly}, which is the pumping capacitor of the charge pump, is 100 [pF] in a system of the imaging element 4, the capacitor C_{fly} is operated with the capacity value set to 10 [pF] in a blank period to suppress power consumption. On the other hand, the capacitor C_{fly} is operated with the capacity value of the capacitor C_{fly} set to 50 [pF] in a read period and the capacitor C_{fly} is operated with the capacity value of the capacitor C_{fly} set to 100 [pF] in a negative potential stabilization waiting period such as global operation periods to increase the driving capability. By performing such control, it is possible to reduce the power consumption in the charge pump as a whole of the operation of the imaging element 4.

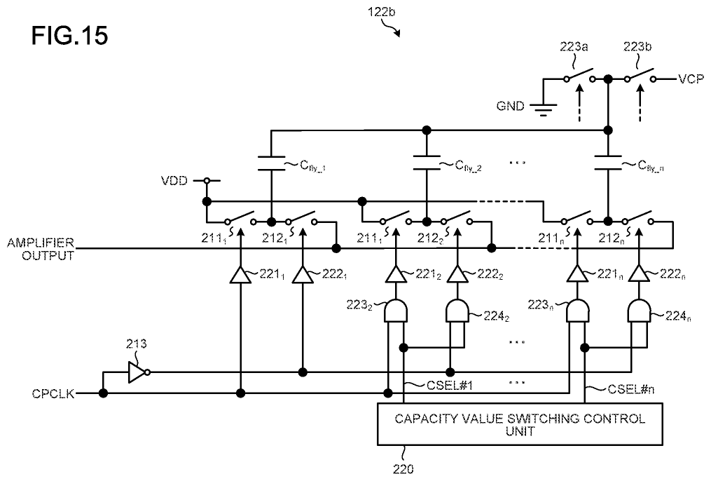

FIG. 14 is a diagram schematically illustrating a configuration of an example of the charge pump according to the third embodiment. In FIG. 14, in the charge pump 122b, the frequency divider 200, the selector 201, and the frequency switching control unit 202 are removed from the configuration of the charge pump 122 illustrated in FIG. 4 and a capacity value switching control unit 220 is added.

Based on the mode signals MODE supplied from the drive signal scanning unit 120, the capacity value switching control unit 220 generates a capacity value switching signal CSEL for controlling the capacity of a capacitor C_{fly}′, which is the pumping capacitor.

Note that the clock signal CPCLK for driving the charge pump 122b is directly input to the inverter 213. Opening and closing of the switch circuits 211a and 211b are controlled on an input side of the inverter 213 and opening and closing of the switch circuits 212a and 212b are controlled on an output side of the inverter 213. That is, the capacitor C_{fly}′ is pumped by the clock signal CPCLK having a constant frequency.

In such a configuration, for example, referring to FIG. 6, the capacity value switching control unit 220 generates, based on the input mode signals MODE, the capacity value switching signal CSEL for reducing the capacity value of the capacitor C_{fly}′ in the blank period. The capacity value switching control unit 220 generates, based on the input mode signals MODE, the capacity value switching signal CSEL for increasing the capacity value of the capacitor C_{fly}′ in a negative potential stabilization waiting period such as a global shutter period and a global reset and transfer period. The capacity value switching control unit 220 generates, based on the input mode signals MODE, the capacity value switching signal CSEL for setting the capacity value of the capacitor C_{fly}′ to medium, for example, in the read period excluding the global shutter period.

In the example explained above, since the capacity value of the capacitor C_{fly}′ is reduced in the blank period, a chargeable charge amount of the capacitor C_{fly}′ is small and power consumption can be suppressed. On the other hand, since the capacity value of the capacitor C_{fly}′ is increased in the negative potential stabilization waiting period, the chargeable charge amount of the capacitor C_{fly}′ increases and the driving capability of the charge pump 122b increases.

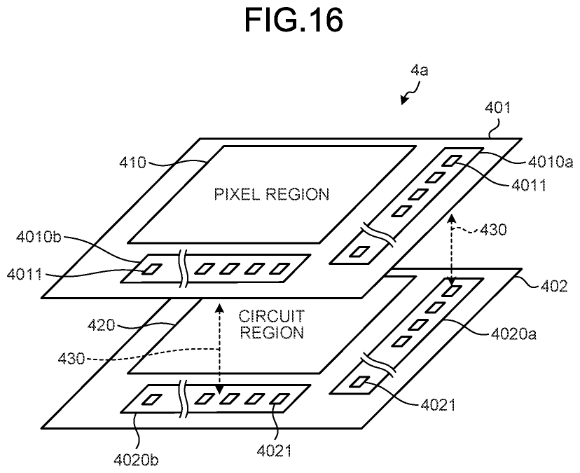

FIG. 15 is a circuit diagram illustrating a configuration example of a capacity value variable circuit in the charge pump 122b according to the third embodiment. In the example illustrated in FIG. 15, the charge pump 122b connects a plurality of capacitors C_{fly_1}, C_{fly_2}, . . . , and C_{fly_n} in parallel and controls the number of capacitors for which the pumping operation is performed in the plurality of capacitors C_{fly_1}, C_{fly_2}, . . . , and C_{fly_n} according to the capacity value switching signal CSEL. Accordingly, the pumping operation is performed with the pumping capacitor is made variable as a whole.

In FIG. 15, the switch circuits 211₁ and 212₁, the switch circuits 211₂ and 212₂, and the switch circuits 211ₙ and 212ₙ respectively correspond to the switch circuits 211b and 212b of FIG. 4. One ends of the respective switch circuits 211₁, 211₂, . . . , and 211n are connected to a power supply line of the positive potential power supply VDD and the other ends are connected to one ends of the respective switch circuits 212₁, 212₂, . . . , and 212ₙ. The other ends of the respective switch circuits 212₁, 212₂, . . . , and 212ₙ are connected to an output of the amplifier 204 (not illustrated).

One end of the capacitor C_{fly_1} is connected to a connection point where the other end of the switch circuit 211₁ and one end of the switch circuit 212₁ are connected. Similarly, in the switch circuits 211₂ and 212₂, . . . , and 211ₙ and 212ₙ, one ends of the capacitors C_{fly_2}, . . . , and C_{fly_n} are connected to connection points where the other ends and one ends of the switch circuits 211₂ and 212₂, . . . , and 211ₙ and 212ₙ, are connected.

On the other hand, one end of the switch circuit 223a is connected to the ground potential and the other end of the switch circuit 223a is connected to one end of the switch circuit 223b. The voltage VCP is output from the other end of the switch circuit 223b. The other ends of the capacitors C_{fly_1}, C_{fly_2}, . . . , and C_{fly_n} are connected in common to a connection point where the other end of the switch circuit 223a and one end of the switch circuit 223b are connected.

The clock signal CPCLK is input to the inverter 213 and is input to a driver amplifier 221₁ and the first input ends of the AND circuits 223₂, . . . , and 223ₙ. An output of the inverter 213 is input to a driver amplifier 222₁ and the first input ends of the respective AND circuits 224₂, . . . , and 224ₙ.

The capacity value switching control unit 220 generates capacity value switching signals CSEL #1, . . . , and CSEL #n. At this time, the capacity value switching control unit 220 controls the high state and the low state of the capacity value switching signals CSEL #1, . . . , and CSEL #n according to the mode signal MODE supplied from the drive signal scanning unit 120. The capacity value switching signals CSEL #1, . . . , and CSEL #n are respectively input to the second input ends of the AND circuits 223₂ and 224₂, . . . , and 223ₙ and 224ₙ.

Outputs of the AND circuits 223₂, . . . , and 223ₙ are respectively input to driver amplifiers 221₂, . . . , and 221ₙ. Similarly, outputs of the AND circuits 224₂, . . . , and 224ₙ are respectively input to driver amplifiers 222₂, . . . , and 222ₙ.

The switch circuits 211₁, 211₂, . . . , and 211ₙ are respectively controlled to be opened and closed according to outputs of driver amplifiers 221₁, 221₂, . . . , and 221ₙ. Similarly, the switch circuits 212₁, 212₂, . . . , and 212ₙ are respectively controlled to be opened and closed according to outputs of driver amplifiers 222₁, 222₂, . . . , and 222ₙ. Although a signal path is omitted, the switch circuit 223a is controlled to be opened and closed according to the clock signal CPCLK and the switch circuit 223b is controlled to be opened and closed according to the clock signal CPCLK inverted by the inverter 213.

That is, the switch circuit 223a and the switch circuits 211₁, 211₂, . . . , and 211ₙ are respectively controlled to be opened and closed in synchronization with the clock signal CPCLK. The switch circuit 223b and the switch circuits 212₁, 212₂, . . . , and 212ₙ are respectively controlled to be opened and closed in synchronization with the clock signal CPCLK and at timing inverted with respect to the switch circuit 223a and the switch circuits 211₁, 211₂, . . . , and 211ₙ.

In such a configuration, based on the mode signal MODE, for example, in the blank period illustrated in FIG. 6, the capacity value switching control unit 220 sets all the capacity switching signals CSEL #1, . . . , and #n to the low state, operates only the switch circuits 211₁ and 212₁, and performs the pumping operation only with the capacitor C_{fly_1}.

On the other hand, the capacity value switching control unit 220 sets a predetermined number (for example, n/2) of signals among the capacity switching signals CSEL #1, . . . , and #n to the high state and sets the other capacity switching signals CSEL to the low state based on the mode signal MODE, for example, in the read period excluding the negative potential stabilization waiting period (for example, the global shutter period) illustrated in FIG. 6. Accordingly, the switch circuits 211₁ and 212₁ and a predetermined number of sets of switch circuits among the switch circuits 211₂ and 212₂, . . . , and 211ₙ and 212ₙ are selectively operated. Therefore, the pumping operation is performed in the capacitor C_{fly_1} and a predetermined number of capacitors among the capacitors C_{fly_2}, . . . , and C_{fly_n} and the charge pump 122b can increase the driving capability with respect to the blank period explained above.

Further, based on the mode signal MODE, for example, in the negative potential stabilization waiting period illustrated in FIG. 6, the capacity value switching control unit 220 sets the number of (all n) signals among the capacity switching signals CSEL #1, . . . , and #n larger than the number of signals in the read period excluding the negative potential stabilization waiting period explained above to the high state. Accordingly, sets of all switch circuits, that is, the switch circuits 211₁ and 212₁ and the switch circuits 211₂ and 212₂, . . . , and 211ₙ and 212ₙ are operated. Therefore, the pumping operation is performed in the capacitor C_{fly_1} and all the capacitors C_{fly_2}, . . . , and C_{fly_n} and the charge pump 122b can increase the driving capability with respect to the read period excluding the negative potential stabilization waiting period explained above.

As explained above, the power consumption of the charge pump 122b as a whole can be suppressed by changing the number of capacitors that perform the pumping operation based on the mode signal MODE. The driving capability of the charge pump 122b as a whole can be increased by increasing the number of capacitors that perform the pumping operation.

Since a charge amount accumulated in the capacitors C_{fly_1}, C_{fly_2}, . . . , and C_{fly_n} changes by a feedback voltage supplied from the amplifier 204, a charge supply amount does not change at least near a target negative potential irrespective of the number of capacitors C_{fly} that perform the pumping operation. However, driver amplifiers that drive the switch circuits 211₁ and 212₁, 211₂ and 212₂, . . . , and 211ₙ and 212ₙ for causing the capacitors C_{fly_1}, C_{fly_2}, . . . , and C_{fly_n} to perform the pumping operation are always operated. Therefore, it is meaningful to stop a set of switch circuits corresponding to the capacitors that do not perform the pumping operation among the capacitors C_{fly_1}, C_{fly_2}, . . . , and C_{fly_n} and the driver amplifier that drives the switch circuits.

Note that the control methods are independent from one another in the example in which the driving capability of the charge pump is controlled according to the frequency of the clock signal according to the first embodiment (and the modifications thereof) explained above, the example in which the driving capability of the charge pump is controlled according to the number of charge pumps to be operated simultaneously according to the second embodiment explained above, and the example in which the driving capability of the charge pump is controlled by making the pumping capacitor variable according to the third embodiment explained above. Therefore, two or more of the first embodiment (and the modifications thereof), the second embodiment, and the third embodiment can be implemented in combination.

It is possible to suppress the power consumption to the utmost limit by, in the blank period, minimizing the number of charge pumps to be simultaneously operated and the pumping capacitor while reducing the frequency of the clock signal for driving the charge pump with the method in the first embodiment (and the modifications thereof).

### 5. Fourth Embodiment

Subsequently, a fourth embodiment is explained. In the first embodiment and the modifications thereof and the second embodiment and the third embodiment explained above, the imaging element 4 is formed on one chip. This is not limited to this example. It is also possible to form the imaging element 4 to be divided into a plurality of chips and form the imaging element 4 as a stacked structure in which the plurality of chips is bonded together. The fourth embodiment is an example in which the imaging element 4 explained above is formed by being divided into two chips and the two chips are bonded together to form a stacked structure.

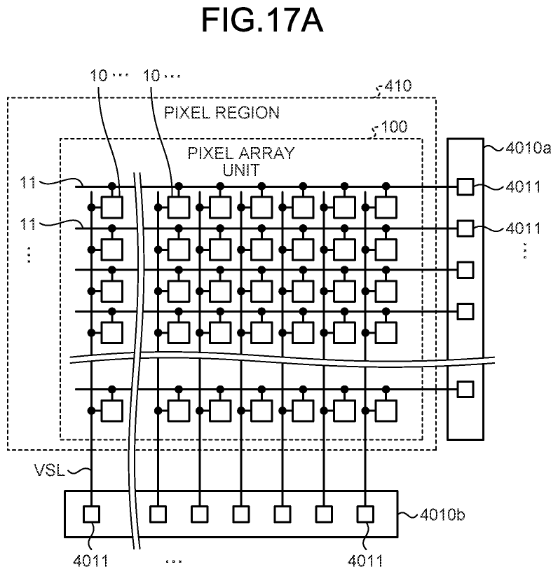

FIG. 16 is a schematic diagram illustrating a configuration of an example of an imaging element according to the fourth embodiment. In the example illustrated in FIG. 16, an imaging element 4a is divided into a first substrate 401 and a second substrate 402, each of which is one chip. As explained in detail below, the first substrate 401 is provided with, for example, a pixel region 410 including the pixel array unit 100 illustrated in FIG. 2. The second substrate 402 is provided with, for example, a circuit region 420 including a portion other than the pixel array unit 100 illustrated in FIG. 2.

Through-electrode portions 4010a and 4010b in which one or more through-electrodes 4011 are respectively disposed are provided around the pixel region 410 of the first substrate 401. The through-electrodes 4011 are connected to signal lines and power supply lines of the pixel array unit 100 arranged in the pixel region 410. Similarly, through-electrode portions 4020a and 4020b in which one or more through-electrodes 4021 are respectively disposed are provided around the circuit region 420 of the second substrate 402. The through-electrodes 4021 disposed in the through-electrode portions 4020a and 4020b and the through-electrodes 4011 disposed on the first substrate 401 are disposed at positions corresponding to each other.

When the first substrate 401 and the second substrate 402 are bonded together, the through-electrode 4011 of the first substrate 401 and the through-electrode 4021 of the second substrate 402, the position of which corresponds to the through-electrode 4011, are connected via connecting portions 430. Parts included in the pixel region 410 and parts included in the circuit region 420 are electrically connected. Accordingly, the imaging element 4a is configured as one solid-state imaging element. A connection scheme of the connecting portion 430 is not particularly limited. However, for example, direct bonding using copper (Cu) can be applied.

In the example illustrated in FIG. 16, the through-electrode portions 4010a and 4010b respectively including the one or more through-electrodes 4011 are illustrated as being provided on two sides of the first substrate 401. The through-electrode portions 4020a and 4020b are illustrated as being provided in positions corresponding to the through-electrode portions 4010a and 4010b of the second substrate 402. However, this is not limited to this example. That is, in the first substrate 401, a through-electrode portion including one or more through-electrodes 4011 may be provided on three sides or four sides of the first substrate 401 or may be provided only on one side of the first substrate 401. Even in this case, a through-electrode portion in the second substrate 402 is provided to correspond to the position of a through-electrode portion in the first substrate 401.

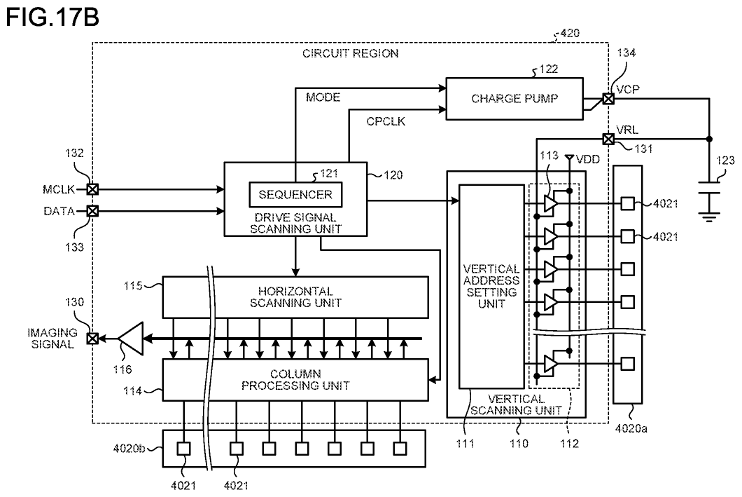

FIG. 17A and FIG. 17B are diagrams illustrating examples of allocation of parts of the imaging element 4a to the first substrate 401 and the second substrate 402, which are applicable to the fourth embodiment. Note that an electrical configuration of the imaging element 4a is assumed to be equivalent to the configuration of the imaging element 4 illustrated in FIG. 2 explained above.

FIG. 17A is a diagram illustrating an example of a case where the pixel array unit 100 illustrated in FIG. 2 is disposed in the pixel region 410 in the first substrate 401. In the example illustrated in FIG. 17A, the pixel signal lines 11 in rows of the pixel array unit 100 are connected to the through-electrodes 4011 of the through-electrode portion 4010a. The vertical signal lines VSL of the pixel array unit 100 are connected to the through-electrodes 4011 of the through-electrode portion 4010b.

FIG. 17B is a diagram illustrating an example of a case where a component other than the pixel array unit 100 among the units in FIG. 2 is arranged in the circuit region 420 in the second substrate 402. In the example illustrated in FIG. 17B, the vertical scanning unit 110, the column processing unit 114, the horizontal scanning unit 115, the buffer amplifier 116, the drive signal scanning unit 120, and the charge pump 122 are disposed in the circuit region 420.

The signal lines led out from the vertical drive unit 112 of the vertical scanning unit 110 are connected to the through-electrodes 4021 included in the through-electrode portion 4020a and are connected to the pixel signal lines 11 of the pixel array unit 100 provided on the first substrate 401 from the through-electrodes 4021 via the connecting portions 430 and the through-electrode 4011 corresponding to the through-electrodes 4021. Similarly, the signal lines led out from the column processing unit 114 are connected to the through-electrodes 4021 included in the through-electrode portion 4020b and are connected to the vertical signal lines VSL of the pixel array unit 100 provided on the first substrate 401 from the through-electrodes 4021 via the connecting portions 430 and the through-electrodes 4011 corresponding to the through-electrodes 4021.

The terminals 130 to 134 are provided to perform electrical connection to the outside of the second substrate 402. That is, in the example illustrated in FIG. 17B, the capacitor 123 for smoothing the voltage VCP output from the charge pump 122 is provided on the outside of the second substrate 402. Not only this, but the capacitor 123 may be provided on the inside of the second substrate 402.

The disposition of the units illustrated in FIG. 17A and FIG. 17B is an example and is not limited to this example. For example, it is conceivable to dispose the vertical scanning unit 110, the column processing unit 114, and the like included in the circuit region 420 of the second substrate 402 in FIG. 17B on the first substrate 401.

In the above explanation, an example in which the imaging element 4a is configured in a two-layer stacked structure is explained. However, this is not limited to this example. For example, the imaging element 4a may be configured in a stacked structure of three or more layers. In this case, for example, it is conceivable to provide the pixel region 410 and the circuit region 420 explained above respectively in a first layer and a second layer and provide a memory region including a memory that accumulates an imaging signal output from the buffer amplifier 116 in a third layer.

### 6. Fifth Embodiment

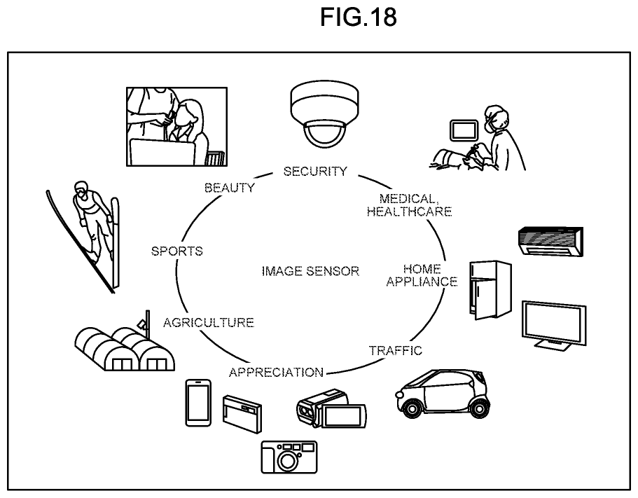

Subsequently, as a fifth embodiment, an application example of the imaging element 4 or the imaging element 4a according to the first embodiment and the modifications thereof and the second, third, and fourth embodiments of the present disclosure are explained. FIG. 18 is a diagram illustrating an example of use of the imaging element 4 or the imaging element 4a according to the first embodiment and the modifications thereof and the second, third, and fourth embodiments explained above.

The imaging elements 4 and 4a explained above can be used, for example, in various cases in which light such as visible light, infrared light, ultraviolet light, and X-rays is used for sensing as described below.
A device that captures an image served for appreciation such as a digital camera or portable equipment with a camera function.
A device served for traffic such as a vehicle-mounted sensor that images the front, rear, surroundings, inside, and the like of an automobile for safe driving such as automatic stop, recognition of a driver's condition, and the like, a monitoring camera that monitors traveling vehicles and roads, and a distance measuring sensor that measures a distance between vehicles and the like.
A device served for use in home appliances such as a TV, a refrigerator, and an air conditioner in order to image a gesture of a user and operate equipment according to the gesture.
A device served for medical or health care such as an endoscope or a device that performs angiography by receiving infrared light.
A device served for security such as a monitoring camera for crime prevention or a camera for person authentication.
A device served for beauty care such as a skin measuring instrument for imaging skin or a microscope for imaging a scalp.
A device served for sports, such as an action camera or a wearable camera for sports or the like.
A device served for agriculture such as a camera for monitoring conditions of fields and crops.

### 6-1. More Specific Example of a Case where the Imaging Element of the Present Disclosure is Mounted on a Vehicle

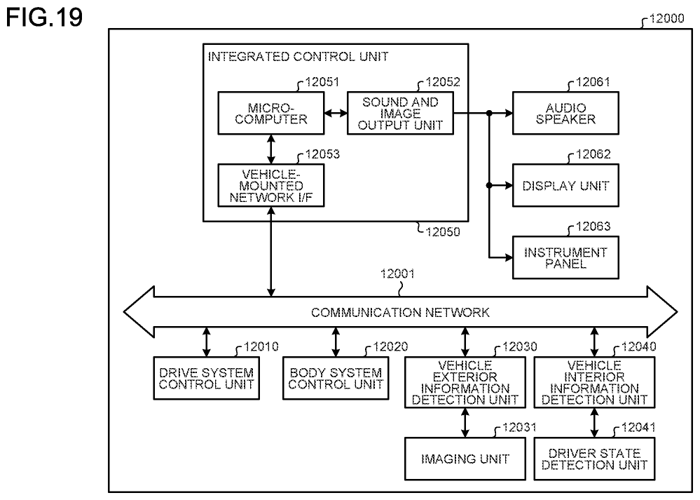

As an application example of the imaging elements 4 and 4a according to the present disclosure, a more specific example in a case where the imaging element 4 or 4a is mounted on a vehicle and used is explained. FIG. 19 is a block diagram illustrating a schematic configuration example of a vehicle control system, which is an example of a mobile body control system to which the technique according to the present disclosure can be applied.

A vehicle control system 12000 includes a plurality of electronic control units connected via a communication network 12001. In the example illustrated in FIG. 19, the vehicle control system 12000 includes a drive system control unit 12010, a body system control unit 12020, a vehicle exterior information detection unit 12030, a vehicle interior information detection unit 12040, and an integrated control unit 12050. As a functional configuration of the integrated control unit 12050, a microcomputer 12051, a sound and image output unit 12052, and a vehicle-mounted network interface (I/F) 12053 are illustrated.

The drive system control unit 12010 controls the operation of devices relating to a drive system of the vehicle according to various programs. For example, the drive system control unit 12010 functions as a control device for a driving force generation device for generating a driving force for the vehicle such as an internal combustion engine or a driving motor, a driving force transmission mechanism for transmitting the driving force to wheels, a steering mechanism for adjusting a steering angle of the vehicle, a braking device for generating a braking force for the vehicle, and the like.

The body system control unit 12020 controls operations of various devices mounted on a vehicle body according to various programs. For example, the body system control unit 12020 functions as a control device for a keyless entry system, a smart key system, a power window device, or various lamps such as a head lamp, a back lamp, a brake lamp, a blinker, or a fog lamp. In this case, radio waves transmitted from a portable device that substitutes for a key or signals of various switches can be input to the body system control unit 12020. The body system control unit 12020 receives input of these radio waves or signals and controls a door lock device, a power window device, the lamps, and the like of the vehicle.

The vehicle exterior information detection unit 12030 detects information on the outside of the vehicle on which the vehicle control system 12000 is mounted. For example, an imaging unit 12031 is connected to the vehicle exterior information detection unit 12030. The vehicle exterior information detection unit 12030 causes the imaging unit 12031 to capture an image of the outside of the vehicle and receives the captured image. The vehicle exterior information detection unit 12030 may perform object detection processing or distance detection processing for a person, a vehicle, an obstacle, a sign, a character on a road surface, or the like based on the received image.

The imaging unit 12031 is an optical sensor that receives light and outputs an electric signal corresponding to an amount of the received light. The imaging unit 12031 can output the electric signal as an image or can output the electric signal as distance measurement information. The light received by the imaging unit 12031 may be visible light or may be invisible light such as infrared rays.

The vehicle interior information detection unit 12040 detects information inside the vehicle. For example, a driver state detection unit 12041 that detects a state of a driver is connected to the vehicle interior information detection unit 12040. The driver state detection unit 12041 includes, for example, a camera that images the driver. Based on detection information input from the driver state detection unit 12041, the vehicle interior information detection unit 12040 may calculate a degree of fatigue or a degree of concentration of a driver or may determine whether the driver is dozing off.

The microcomputer 12051 can calculate a control target value of the driving force generation device, the steering mechanism, or the braking device based on the information inside and outside the vehicle acquired by the vehicle exterior information detection unit 12030 or the vehicle interior information detection unit 12040 and output a control command to the drive system control unit 12010. For example, the microcomputer 12051 can perform cooperative control for the purpose of implementing functions of an advanced driver assistance system (ADAS) including collision avoidance or impact mitigation for the vehicle, following travel based on an inter-vehicle distance, vehicle speed maintenance traveling, vehicle collision warning, vehicle lane departure warning, or the like.

By controlling the driving force generation device, the steering mechanism, the braking device, or the like based on information around the vehicle acquired by the vehicle exterior information detection unit 12030 or the vehicle interior information detection unit 12040, the microcomputer 12051 can perform cooperative control for the purpose of automatic driving or the like in which the vehicle autonomously travels without depending on the operation of the driver.

The microcomputer 12051 can output a control command to the body system control unit 12020 based on the vehicle exterior information acquired by the vehicle exterior information detection unit 12030. For example, the microcomputer 12051 can control a head lamp according to the position of a preceding vehicle or an oncoming vehicle detected by the vehicle exterior information detection unit 12030 and perform cooperative control for the purpose of preventing glare such as switching from a high beam to a low beam.

The sound and image output unit 12052 transmits an output signal of at least one of sound or an image to an output device capable of visually or audibly notifying an occupant of the vehicle or the outside of the vehicle of information. In the example illustrated in FIG. 19, an audio speaker 12061, a display unit 12062, and an instrument panel 12063 are illustrated as the output device. The display unit 12062 may include, for example, at least one of an on-board display and a head-up display.

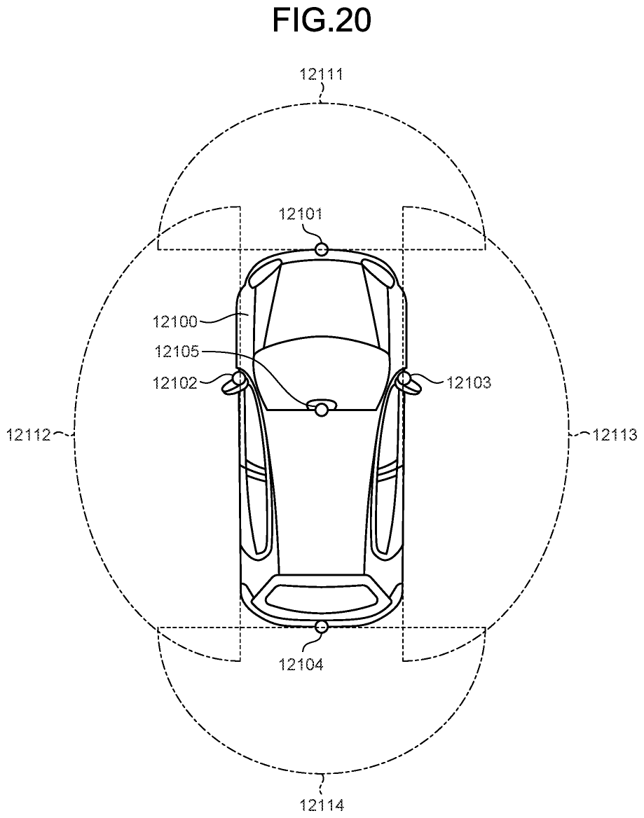

FIG. 20 is a diagram illustrating an example of a setting position of the imaging unit 12031. In FIG. 20, a vehicle 12100 includes imaging units 12101, 12102, 12103, 12104, and 12105 as the imaging unit 12031.

The imaging units 12101, 12102, 12103, 12104, and 12105 are provided, for example, in positions such as a front nose, a side mirror, a rear bumper, a back door, and an upper portion of a windshield in a vehicle interior of the vehicle 12100. The imaging unit 12101 provided in the front nose and the imaging unit 12105 provided in the upper portion of the windshield in the vehicle interior mainly acquire images in the front of the vehicle 12100. The imaging units 12102 and 12103 provided in the side mirrors mainly acquire images of the sides of the vehicle 12100. The imaging unit 12104 provided in the rear bumper or the back door mainly acquires an image behind the vehicle 12100. Front images acquired by the imaging units 12101 and 12105 are mainly used for detecting a preceding vehicle, a pedestrian, an obstacle, a traffic light, a traffic sign, a lane, or the like.

Note that FIG. 25 illustrates an example of imaging ranges of the imaging units 12101 to 12104. An imaging range 12111 indicates an imaging range of the imaging unit 12101 provided in the front nose, imaging ranges 12112 and 12113 respectively indicate imaging ranges of the imaging units 12102 and 12103 provided in the side mirrors, and an imaging range 12114 indicates an imaging range of the imaging unit 12104 provided at the rear bumper or the back door. For example, a bird's-eye view image of the vehicle 12100 viewed from above is obtained by superimposing image data captured by the imaging units 12101 to 12104.

At least one of the imaging units 12101 to 12104 may have a function of acquiring distance information. For example, at least one of the imaging units 12101 to 12104 may be a stereo camera including a plurality of imaging elements or may be an imaging element including pixels for phase difference detection.

For example, the microcomputer 12051 can obtain distances to three-dimensional objects in the imaging ranges 12111 to 12114 and temporal changes of the distances (relative speed with respect to the vehicle 12100) based on distance information obtained from the imaging units 12101 to 12104 to thereby extract, as a preceding vehicle, in particular, a closest three-dimensional object present on a traveling path of the vehicle 12100, the three-dimensional object traveling at a predetermined speed (for example, 0 km/h or more) in substantially the same direction as the vehicle 12100. Further, the microcomputer 12051 can set an inter-vehicle distance to be secured in advance in the front of the preceding vehicle and perform automatic brake control (including following stop control), automatic acceleration control (including following start control), and the like. As explained above, it is possible to perform cooperative control for the purpose of automatic driving or the like in which the vehicle autonomously travels without depending on the operation of the driver.

For example, based on the distance information obtained from the imaging units 12101 to 12104, the microcomputer 12051 can classify three-dimensional object data regarding three-dimensional objects into two-wheeled vehicles, ordinary vehicles, large vehicles, pedestrians, and other three-dimensional objects such as utility poles, extract the three-dimensional object data, and use the three-dimensional object data for automatic avoidance of obstacles. For example, the microcomputer 12051 identifies obstacles around the vehicle 12100 as obstacles that can be visually recognized by the driver of the vehicle 12100 and obstacles that are difficult for the driver to visually recognize. the microcomputer 12051 can determine a collision risk indicating a risk of collision with obstacles and, when the collision risk is a set value or more and there is a possibility of collision, perform driving assistance for collision avoidance by outputting an alarm to the driver via the audio speaker 12061 or the display unit 12062 or performing forced deceleration or avoidance steering via the drive system control unit 12010.

At least one of the imaging units 12101 to 12104 may be an infrared camera that detects infrared rays. For example, the microcomputer 12051 can recognize a pedestrian by determining whether the pedestrian is present in captured images of the imaging units 12101 to 12104. Such pedestrian recognition is performed by, for example, a procedure for extracting feature points in the captured images of the imaging units 12101 to 12104 functioning as infrared cameras and a procedure for performing pattern matching processing on a series of feature points indicating the contour of an object to determine whether the object is a pedestrian. When the microcomputer 12051 determines that a pedestrian is present in the captured images of the imaging units 12101 to 12104 and recognizes the pedestrian, the sound and image output unit 12052 controls the display unit 12062 to superimpose and display a square contour line for emphasis on the recognized pedestrian. The sound and image output unit 12052 may control the display unit 12062 to display an icon or the like indicating a pedestrian in a desired position.

The example of the vehicle control system to which the technique according to the present disclosure can be applied is explained above. The technique according to the present disclosure can be applied to, for example, the imaging unit 12031 among the components explained above. Specifically, the imaging element 4 or 4a according to the first embodiment and the modifications thereof and the second, third, and fourth embodiments of the present disclosure can be applied to the imaging unit 12031. By applying the technique according to the present disclosure to the imaging unit 12031, it is possible to reduce power consumption in the imaging unit 12031. For example, when the imaging unit 12031 is driven by a battery, operation for a longer time is possible.

Note that the effects described in this specification are only illustrations and are not limited. Other effects may be present.

Note that this technique can also take the following configurations.
(1) An imaging element comprising:
   an imaging unit in which pixels including a light receiving element are arrayed;
   a drive unit that generates a drive signal for driving the pixels;
   a charge pump circuit that generates electric power for driving the drive unit; and
   a control unit that controls, according to an operation of the imaging unit, a driving capability of the charge pump circuit to drive the drive unit.
(2) The imaging element according to the above (1), further comprising a clock generation unit that generates a clock signal for driving the charge pump circuit, wherein
   the control unit
   controls, according to the operation, the driving capability by controlling a frequency of the clock signal generated by the clock generation unit.
(3) The imaging element according to the above (2), wherein the clock generation unit includes:
   a signal generation unit that generates a plurality of clock signals respectively having different frequencies as the clock signal; and
   a selection unit that selects the clock signal to be supplied to the charge pump circuit from the plurality of clock signals generated by the signal generation unit, and
   the control unit controls the driving capability by controlling the selection of the clock signal by the selection unit according to the operation.
(4) The imaging element according to the above (3), further comprising a plurality of synchronization units that synchronizes each of the plurality of clock signals generated by the signal generation unit with timing when the operation is switched, the plurality of synchronization units corresponding to each of the plurality of clock signals in a one-to-one relation, wherein
   the selection unit
   selects a clock signal to be supplied to the charge pump circuit from each of the plurality of clock signals output from each of the plurality of synchronization units according to control of the control unit.
(5) The imaging element according to the above (3), further comprising a plurality of synchronization units that synchronizes each of the plurality of clock signals generated by the signal generation unit with timing when the operation is switched, the plurality of synchronization units corresponding to each of the plurality of clock signals in a one-to-one relation, wherein
   the selection unit
   selects a clock signal to be input to any one of the plurality of synchronization units from each of the plurality of clock signals according to control of the control unit.
(6) The imaging element according to the above (3), wherein
   the clock generation unit
   includes a plurality of signal generation units that generates the clock signals respectively having different frequencies, and
   the selection unit
   selects one signal generation unit from the plurality of signal generation units according to control of the control unit.
(7) The imaging element according to the above (1), wherein
   the charge pump circuit includes a plurality of charge pump circuits capable of operating in parallel, and
   the control unit
   controls, according to the operation, the number of charge pump circuits to be simultaneously used among the plurality of charge pump circuits.
(8) The imaging element according to the above (1), wherein
   the charge pump circuit includes a pumping capacitor for performing accumulation of electric charges according to a clock signal, and
   the control unit
   changes the pumping capacitor according to the operation.
(9) The imaging element according to the above (8), wherein
   the charge pump circuit
   includes a plurality of the pumping capacitors connected in parallel, and
   the control unit
   controls, according to the operation, the number of pumping capacitors for performing the accumulation of the electric charges among the plurality of the pumping capacitors connected in parallel.
(10) The imaging element according to any one of the above (1) to (9), wherein
   the control unit
   generates a plurality of mode signals indicating a respective plurality of operations of the imaging unit and controls the driving capability according to a combination of the plurality of mode signals.
(11) The imaging element according to the above (10), further including a clock generation unit that generates a clock signal for driving the charge pump circuit, wherein
   the control unit
   generates the plurality of mode signals including a first mode signal indicating the operation in a blank period, a second mode signal indicating the operation in a read period, a third mode signal indicating the operation in a global reset and transfer period, and a fourth mode signal indicating the operation in a global shutter period,
   the clock generation unit
   generates the clock signal having a first frequency in a period in which the third mode signal and the fourth mode signal are valid,
   generates the clock signal having a second frequency lower than the first frequency in a period in which the second mode signal is valid and the fourth mode signal and the third mode signal are invalid, and
   generates the clock signal having a third frequency lower than the second frequency in a period in which the first mode signal is valid and the second mode signal, the third mode signal, and the fourth mode signal are invalid.
(12) The imaging element according to any one of the above (1) to (11), wherein
   the imaging unit, the drive unit, the charge pump circuit, and the control unit are disposed on a same semiconductor chip.
(13) The imaging element according to any one of the above (1) to (11), further comprising:
   a first semiconductor chip on which the imaging unit is disposed; and
   a second semiconductor chip on which the drive unit, the charge pump circuit, and the control unit are disposed, the second semiconductor chip being stacked on the first semiconductor chip.
(14) An imaging apparatus comprising:
   an imaging element including:
   an imaging unit in which pixels including a light receiving element are arrayed;
   a drive unit that generates a drive signal for driving the pixels;
   a charge pump circuit that generates electric power for driving the drive unit; and
   a control unit that controls, according to an operation of the imaging unit, a driving capability of the charge pump circuit to drive the drive unit;
   an image processing unit that executes image processing on an imaging signal output from the imaging unit and generates image data; and
   a storing unit that stores the image data generated by the image processing unit.

### REFERENCE SIGNS LIST

1 ELECTRONIC EQUIPMENT
4, 4a IMAGING ELEMENT
10 PIXEL
11 PIXEL SIGNAL LINE
100 PIXEL ARRAY UNIT
110 VERTICAL SCANNING UNIT
112 VERTICAL DRIVE UNIT
114 COLUMN PROCESSING UNIT
115 HORIZONTAL SCANNING UNIT
120 DRIVE SIGNAL SCANNING UNIT
121 SEQUENCER
122, 122a, 122b, 1222₁, 1222₂, 1222ₙ CHARGE PUMP
200 FREQUENCY DIVIDER
201, 201a, 201b SELECTOR
202 FREQUENCY SWITCHING CONTROL UNIT
220 CAPACITY VALUE SWITCHING CONTROL UNIT
401 FIRST SUBSTRATE
402 SECOND SUBSTRATE
410 PIXEL REGION
420 CIRCUIT REGION
1220 STANDBY SWITCHING CONTROL UNIT
2010 SYNCHRONIZATION CIRCUIT
2040 FREQUENCY DIVIDER UNIT

1. An imaging element comprising:
an imaging unit in which pixels including a light receiving element are arrayed;
a drive unit that generates a drive signal for driving the pixels;
a charge pump circuit that generates electric power for driving the drive unit; and
a control unit that controls, according to an operation of the imaging unit, a driving capability of the charge pump circuit to drive the drive unit.

2. The imaging element according to claim 1, further comprising a clock generation unit that generates a clock signal for driving the charge pump circuit, wherein
the control unit
controls, according to the operation, the driving capability by controlling a frequency of the clock signal generated by the clock generation unit.

3. The imaging element according to claim 2, wherein the clock generation unit includes:
a signal generation unit that generates a plurality of clock signals respectively having different frequencies as the clock signal; and
a selection unit that selects the clock signal to be supplied to the charge pump circuit from the plurality of clock signals generated by the signal generation unit, and
the control unit controls the driving capability by controlling the selection of the clock signal by the selection unit according to the operation.

4. The imaging element according to claim 3, further comprising a plurality of synchronization units that synchronizes each of the plurality of clock signals generated by the signal generation unit with timing when the operation is switched, the plurality of synchronization units corresponding to each of the plurality of clock signals in a one-to-one relation, wherein
the selection unit
selects a clock signal to be supplied to the charge pump circuit from each of the plurality of clock signals output from each of the plurality of synchronization units according to control of the control unit.

5. The imaging element according to claim 3, further comprising a plurality of synchronization units that synchronizes each of the plurality of clock signals generated by the signal generation unit with timing when the operation is switched, the plurality of synchronization units corresponding to each of the plurality of clock signals in a one-to-one relation, wherein
the selection unit
selects a clock signal to be input to any one of the plurality of synchronization units from each of the plurality of clock signals according to control of the control unit.

6. The imaging element according to claim 3, wherein
the clock generation unit
includes a plurality of signal generation units that generates the clock signals respectively having different frequencies, and
the selection unit
selects one signal generation unit from the plurality of signal generation units according to control of the control unit.

7. The imaging element according to claim 1, wherein
the charge pump circuit includes a plurality of charge pump circuits capable of operating in parallel, and
the control unit
controls, according to the operation, the number of charge pump circuits to be simultaneously used among the plurality of charge pump circuits.

8. The imaging element according to claim 1, wherein
the charge pump circuit includes a pumping capacitor for performing accumulation of electric charges according to a clock signal, and
the control unit
changes the pumping capacitor according to the operation.

9. The imaging element according to claim 8, wherein
the charge pump circuit
includes a plurality of the pumping capacitors connected in parallel, and
the control unit
controls, according to the operation, the number of pumping capacitors for performing the accumulation of the electric charges among the plurality of the pumping capacitors connected in parallel.

10. The imaging element according to claim 1, wherein
the control unit
generates a plurality of mode signals indicating a respective plurality of operations of the imaging unit and controls the driving capability according to a combination of the plurality of mode signals.

11. The imaging element according to claim 10, further comprising a clock generation unit that generates a clock signal for driving the charge pump circuit, wherein
the control unit
generates the plurality of mode signals including a first mode signal indicating the operation in a blank period, a second mode signal indicating the operation in a read period, a third mode signal indicating the operation in a global reset and transfer period, and a fourth mode signal indicating the operation in a global shutter period, and
the clock generation unit
controls the driving capability to a first driving capability in a period in which the third mode signal and the fourth mode signal are valid,
controls the driving capability to a second driving capability lower than the first driving capability in a period in which the second mode signal is valid and the fourth mode signal and the third mode signal are invalid, and
controls the driving capability to a third driving capability lower than the second driving capability in a period in which the first mode signal is valid and the second mode signal, the third mode signal, and the fourth mode signal are invalid.

12. The imaging element according to claim 1, wherein
the imaging unit, the drive unit, the charge pump circuit, and the control unit are disposed on a same semiconductor chip.

13. The imaging element according to claim 1, further comprising:
a first semiconductor chip on which the imaging unit is disposed; and
a second semiconductor chip on which the drive unit, the charge pump circuit, and the control unit are disposed, the second semiconductor chip being stacked on the first semiconductor chip.

14. An imaging apparatus comprising:
an imaging element including:
an imaging unit in which pixels including a light receiving element are arrayed;
a drive unit that generates a drive signal for driving the pixels;
a charge pump circuit that generates electric power for driving the drive unit; and
a control unit that controls, according to an operation of the imaging unit, a driving capability of the charge pump circuit to drive the drive unit;
an image processing unit that executes image processing on an imaging signal output from the imaging unit and generates image data; and
a storing unit that stores the image data generated by the image processing unit.
